(19) United States
(12) Patent Application Publication
(10) Pub. No.: US 2026/0338617 A1
(43) Pub. Date: Oct. 29, 2026

(54) DEVICE FOR INDICATING TEMPERATURE RISE ABOVE A THRESHOLD VALUE

(71) Applicant: OBSHCHESTVO S OGRANICHENNOI OTVETSTVENNOSTIU "TERMOELEKTRIKA", Moscow (RU)

(72) Inventors: Aleksei Valerevich LESIV, g. Dolgoprudnyi (RU); Stanislav Anatolevich AMELICHEV, g. Dolgoprudnyi (RU); Elizavata Alekseevna GERASIMCHUK, Moscow (RU); EkATERINA Aleksandrovna KNIAZEVA, Moscow (RU)

(21) Appl. No.: 19/116,918

(22) PCT Filed: Oct. 3, 2022
(86) PCT No.: PCT/RU2022/000300

§ 371 Date: Mar. 28, 2025

(30) Foreign Application Priority Data
Sep. 28, 2022 (RU) 2022125417

(51) Int. Cl. G01K 11/18; G01K 11/16; G09F 3/02

(52) U.S. Cl. CPC G01K 11/18; G01K 11/16; G09F 3/02; G09F 2003/0216

(57) ABSTRACT

The patent relates to devices for recording the excess of threshold temperature, namely to devices that are elastic labels for recording the excess of threshold temperature. The device for recording the excess of threshold temperature, which is an elastic label having a layered structure including: an adhesive layer; a colored elastic base containing at least 5 mass % of halogen atoms, onto which information is applied, including a numerical value of the threshold temperature being recorded; a heat-sensitive material applied to a section of the front surface of the base, made with the ability of visually recording overheating due to an irreversible change in transparency relative to the original state when heated in the range of ±5 °C from the threshold temperature indicated on the label, and including a solid organic substance with a structural fragment of CₙH₍₂ₙ₊₁₎, where n≥5; an elastic protective film, transparent at least to part of visible light, covering the front surface of the base and the heat-sensitive material, wherein the device is designed with the ability to maintain the function of visually recording overheating in the range of ±5 °C from the threshold temperature indicated on the label after its mounting on a cylindrical surface, the minimum radius of curvature of which is 2 mm, as well as after longitudinal and transverse stretching by 10% relative to the original size. The specified patent increases the safe operation of various equipment, including electrical equipment, due to the possibility of tightly fitting the device to surfaces of complex geometry, as well as to surfaces whose linear dimensions can increase within 10%, while maintaining the ability to accurately record the excess of threshold temperatures.

### FIELD OF TECHNOLOGY TO WHICH THE SPECIFIED PATENT RELATES

The patent relates to devices for recording the excess of threshold temperatures, namely to devices that are elastic labels for recording the excess of threshold temperatures.

### STATE OF THE ART

An increase in temperature is one of the first and most common signs of developing defects in various equipment, such as an increase in transient contact resistance in the electrical power industry, malfunctions of bearings in mechanics, interturn short circuits in the windings of electric motors, failure of chargers or batteries in household appliances. Timely detection of such overheating makes it possible to eliminate the malfunction in advance and prevent equipment failure, emergency situations and associated fires or shutdowns. Technical and regulatory documents establish maximum permissible temperatures, heating above which should be considered a defect requiring immediate cessation of operation and removal of equipment for repair (for example, RD 34.45-51.300-97, RD 153-34.0-20.363-99, GOST 8865-93, 8024-90, 10693-81, 2213-79, 10434-82, 16708-84, 2585-81, 32397-2020, 26346-84, 839-2019, GOST R 51321.1-2007, etc.).

Various diagnostic methods are used to identify defects associated with exceeding maximum permissible temperatures. Means of continuous monitoring of overheating include chemical or mechanical temperature indicators, which can be of two types: reversible (changing appearance only when heated and returning it when cooled) and irreversible (changing appearance after exceeding a given temperature and maintaining it after cooling).

An example of reversible devices for monitoring overheating is the invention described in document U.S. Pat. No. 7,600,912B2 (publication date 20 Mar. 2007) and which is a single-layer or two-layer label, the heat-sensitive element of which contains leuco dyes and a developer in a binder. When a certain temperature is reached, the binder melts and the developer reacts with the dye, coloring the label. After lowering the temperature, the dye crystallizes and the color is restored.

An inorganic reversible temperature indicator based on a chromobratlumine (III) complex compound is described in document RU2561737C1 (publication date 12 Sep. 2014). The proposed thermochromic material has the ability to reversibly change color when heated above a temperature of 120 °C. A feature of this kind of invention is the need to visually record heating at the moment the temperature is exceeded without the ability to detect defects outside of peak loads, so these devices are not widely used.

Unlike reversible indicators, irreversible indicators allow not only to identify, but also to record the fact that a threshold temperature has been exceeded. Moreover, inspection of such devices can be carried out without creating a maximum load mode and even on equipment taken out for repair.

As mentioned earlier, temperature indicators are applied in a wide variety of areas, however, perhaps the most stringent and complex requirements are imposed on temperature indicators used in the energy sector.

So, the device must have a number of necessary characteristics in order to safely use temperature indicators in the energy sector:
have low combustibility and flammability;
have high electrical strength and dielectric properties;
irreversibly record the excess of threshold temperatures with high accuracy;
be flexible and durable;
have strong adhesive properties for tight fit to various surfaces.

At the same time, the device with these characteristics can be easily used in any other field.

Irreversible heating indicators can be classified according to their operating principle. Indicators are known that are based on the mechanical destruction of a heat-sensitive element, on the chemical reaction of the components of the composition, or on the phase transition of a heat-sensitive component.

An example of a temperature indicator based on mechanical destruction is described in the source [U.S. Pat. No. 6,176,197B1, publication date 2 Nov. 1998], according to which the temperature indicator is a closed hollow transparent elongated tube with two compositions of different colors, isolated from each other by a polymer partition having a melting temperature close to the melting temperatures of the compositions. When a given threshold temperature is reached, the partition is destroyed, the compositions melt and mix, as a result of which the color of the contents of the tube changes. The features of the invention include the impossibility of monitoring the overheating of the entire surface, low operating speed, since, to complete the color transition, it is necessary not only to completely melt the indicator composition and the polymer membrane separating them, but also the time for mixing the resulting liquid phases, which may be difficult due to insufficiently fast diffusion processes nearby melting point. In addition, the design features of the described invention do not allow creating a flexible device that fits tightly to the entire surface to be monitored.

The chemical reaction of etching a metal substrate with an activator, which begins when a certain temperature is reached, is described in the patent [EP2288879B1, publication date 4 Jun. 2008]. The indicator changes color from silvery-white or mirror-like to colorless and can be used to monitor temperature in food, medical, and electrical equipment. The metal layer and the activator layer can be applied to a thin film made in the form of a label, which ensures the flexibility of the product and the ability to be fixed to various surfaces. Another example of a temperature indicator based on chemical interaction is the invention described in the source [U.S. Pat. No. 6,957,623B2, publication date 9 Sep. 2004]. The heat-sensitive material in this case contains a mixture of water, latex and ice-forming active microorganisms and is transparent until a threshold temperature is reached. When heated to a given temperature, latex and ice-forming active microorganisms interact with each other to form a non-transparent material. Among the commercially available indicators, the operating principle of which is based on the occurrence of a chemical reaction, we can highlight the indicator of the Retomark model, supplied by YALOS Innovation Company LLC (https://www.yalosindicator.com/product/termoindikatory-kontrol-temperatury).

The presented irreversible thermal indicators, the operating principle of which is based on chemical reactions, are characterized by low accuracy, since the degree of occurrence of a chemical reaction is determined not only by temperature, but also by time in accordance with the Arrhenius equation. Therefore, prolonged exposure of the composition to a temperature slightly lower than the threshold value will also lead to the product operation. At the same time, the above standards regulate specific threshold temperature values with an interval of no more than 5 °C, which makes the described inventions unsuitable for identifying defects. Another feature of such devices is the presence of a pronounced dependence of the operating time on temperature: with short-term heating to a threshold value, the chemical reaction may not be completed and a change in the color of the indicator either will not occur or will be insufficient for detection. In addition, due to the reversibility of color transition reactions, the appearance of some products returns to their original state after prolonged exposure at low temperatures.

Another significant disadvantage of indicators based on mechanical destruction or chemical reaction is that when the layer of the heat-sensitive element is deformed, the indicator may operate prematurely. Therefore, they are not intended for use on uneven or curved surfaces, as well as on surfaces that can change their linear parameters, where their deformation may occur, leading to a loss of functional properties.

The most accurate temperature indicators are those based on a phase transition, namely, on the melting of a heat-sensitive component. Since, unlike a chemical reaction, the temperature of the phase transition does not depend on the exposure time, such indicators have the greatest accuracy and are capable of maintaining their original appearance at a temperature slightly lower than the threshold temperature. Also, indicators based on phase transition are less susceptible to premature operation when deformed, i.e. they do not lose their functional properties and can be used on uneven and curved surfaces, as well as on surfaces that can change their linear parameters, when using certain classes of substances and a suitable base.

In addition, the use of a heat-sensitive material based on phase transition allows the use of a thinner and more uniform layer of material, compared to, for example, materials whose action is based on a chemical reaction, which, among other things, has a positive effect on the flexibility of temperature indicators.

Irreversible indicators based on the principle of phase transition of a heat-sensitive component can be made in the form of special indicator devices (such as labels, cambric, clips, etc.), in which a hot-melt composition is factory-applied evenly, in a thin layer, onto a base that ensures good adhesion to the required surface, and is additionally covered with a polymer film, which protects the hot-melt composition from mechanical or chemical influence and does not allow it to flow out when melted after operation.

Temperature indicators in the form of labels are the most widely used, in particular due to their ease of installation, availability and usability.

Irreversible temperature indicators can be made in single-temperature and multi-temperature versions. Multi-temperature indicators, as a rule, are labels, among the manufacturers of which can be: OOO “TermoElektrika” (https://www.lesiv.pro/%D0%BA%D0%BE%D0%BF%D0%B8%D1%8F-1-mark-pro), OOO “Innovative Company “YALOS” (https://www.yalosindicator.com/product/termoindikatory-kontrol-temperatury), ZAO “NPF “Lyuminofor” (https://luminophor.ru/catalog/termoindikatornye-materialy/termoindikatory-plavleniya-marki-tin/).

The advantage of irreversible multi-temperature indicator devices is that they make it possible to determine not only the fact that a given temperature has been exceeded, but also to determine the numerical value of the maximum surface temperature to which the controlled element was heated during operation. However, since most electrical devices and electrical installation components are regulated by only one maximum permissible temperature value, the use of multi-temperature indicators can lead to uncertainty during inspections. Thus, single-temperature indicators provide a clear understanding of the occurrence of defects in various equipment, accompanied by exceeding the threshold temperature.

A partial change in the color of the temperature indicator is not enough to decide whether there is a defect: it is necessary to additionally find out the maximum permissible temperature value for the controlled element, to compare it with the found value and only then to make a decision on the need to immediately take the equipment out for repairs. In addition, due to the design feature, each temperature window monitors its own surface area, so each indicator element will measure the temperature of its own section of the surface (insulation) and when spot heating occurs, its values will not correspond to the maximum temperature of the entire surface.

Materials with low combustibility and flammability; high electrical strength and dielectric properties; sufficient mechanical strength, etc. should be used as label materials.

The high electrical strength of the individual layers of the label and the device as a whole is necessary to ensure safe use in electrical installations, motors or various electrical mechanisms. The absence of conductivity and high breakdown voltage allows to prevent electrical circuit failure, short circuit or electric arc ignition when the label comes into contact with open current conducting elements.

It should also be taken into account that in the presence of an emergency defect, the heating of the contact can reach the self-ignition temperatures of the label. The ignition of the label, in turn, can lead to a fire in the electrical installation or the occurrence of an electric arc.

In order to use temperature indicators to recording the excess of the temperature of the surface of electrical equipment elements or various mechanisms, it is necessary to take into account that the surface of such elements often has a complex geometry with a curvature radius of 2 mm (for example, small-section electric wire cores with or without insulation, steel-aluminum wires of overhead power lines, apparatus clamps, surface of coils, blades of bolted contact connections, contact lamellas, jaws of fuse contact connections, etc.), these can also be the surfaces of metal current-conducting elements operating in a wide range of temperatures due to the passing electric current or external heating/cooling and, as a result, changing their linear dimensions in a significant range. Other equipment elements, in particular electric motors, batteries, and bearings, also have complex surfaces.

Therefore, in order to reliably record the excess of temperature, it is important that the device (in particular, one made in the form of a label) has a high degree of elasticity and flexibility to adhere to such surfaces reliably and not even partially adhere off from them during operation. Otherwise, if the label does not have sufficient elasticity and flexibility, then after the pressure with which it was adhered is removed, the elastic force will exceed the adhesion (the force of adhesion of the label to the surface), as a result of which the label will tend to take its original shape and partially or completely adhere off from the surface. The same thing can happen when the linear dimensions of the controlled surface change, including due to temperature expansion of the surface material when it is heated.

Manufacturers of temperature indicator labels often indicate in their documentation the necessity of mounting their products on flat surfaces, which is probably due to their insufficient flexibility and elasticity, as well as the fact that deformation may result in a loss of the functional properties of heat-sensitive materials.

In this case, if the base of the label, which has the properties of temperature indicators, does not have elasticity and flexibility and/or the heat-sensitive composition loses its functional properties upon deformation, then when using it for temperature control of surfaces with a small radius of curvature, surfaces of complex shape, as well as surfaces capable of changing their linear parameters, the reliability of recording the excess of temperatures will be significantly reduced due to the following:
in the case of using heat-sensitive materials based on membrane destruction, their premature operation may occur due to physical damage to the integrity of the device elements;
due to insufficient elasticity of the base, the heat-sensitive material may peel off from the base, as well as the cracks may form on its surface, which will lead to insufficient heating of the heat-sensitive material at the moment of exceeding the threshold temperature (T(surface) greater than T(heat-sensitive material)), as well as to reduced visibility of the operated device;
in the zone where the label peels off from the controlled surface, an air bubble may form, which will act as thermal insulation, thereby creating a significant temperature difference between the temperature of the surface and the temperature of the heat-sensitive material (T(surface) greater than T(heat-sensitive material)), due to insufficient heating of the heat-sensitive material;
uneven heating of the surface of the heat-sensitive material in the zone of peeling off of the label or material, in which a part of the layer of the heat-sensitive material changes its appearance (becomes transparent with the development of the base color), and a part retains its original (non-transparent) state, which may lead to an unreliable conclusion about the location of the recorded overheating.

Many prior art temperature indication labels use a transparent protective layer that covers the front surface of the base with applied areas of heat-sensitive materials and protects the heat-sensitive material from negative environmental factors, as well as prevents the heat-sensitive material from spreading when the threshold temperature is exceeded.

It is equally important that the said protective layer of the label also has elasticity and flexibility. When using the non-elastic and non-flexible protective layer for temperature control of surfaces with a small radius of curvature, surfaces of complex shape, as well as surfaces capable of changing their linear parameters, the reliability of recording the excess of temperatures will be significantly reduced due to the following:
the protective film may break, causing a loss of its functional properties, which, as a consequence, will lead to a deterioration in the properties of heat-sensitive materials;
when the protective film is stretched, microcracks may form, due to which the transparency of the film will be reduced, which, as a consequence, will lead to insufficient contrast of the color transition of the label when the threshold temperatures are exceeded;
if the label is placed on devices with a small radius of curvature, the protective film will create excess pressure on the heat-sensitive material, thereby reducing the threshold temperature of its operation.

Thus, in order to reliably record overheating of the surface of electrical equipment elements above the threshold temperature value, among other things, it is necessary to tightly fit the device to the surface for which temperature control is performed, including surfaces with a small radius of curvature, surfaces of complex shape, as well as surfaces capable of increasing their linear parameters, as well as maintaining the functional properties (accuracy of operation) of the heat-sensitive material when used on such surfaces.

Based on our detailed study of the state of the art, it follows that, despite the large selection of temperature indicators, different both in the mechanism of action and in the number of threshold temperatures recorded, there remains a need for devices for recording the excess of threshold temperature, ensuring the possibility of their safe and effective use on surfaces, including complex geometry with a small radius of curvature from 2 mm, as well as on surfaces whose linear dimensions can increase within 10%, including electrical equipment elements.

Thus, there is a need to create the device for recording the excess o threshold temperature of surfaces, including electrical equipment elements, made with the possibility of permanent tight fit to surfaces of complex geometry, including current-conducting electrical equipment element with a radius of curvature of 2 mm, as well as to surfaces whose linear dimensions can increase within 10%.

The prototype of the specified device is temperature indicator labels produced by the Japanese company NiGK Corporation (https://contents.bownow.jp/files/index/sid_9c257787049ca562bbda?client_id=d867dc3c-ab2f-4a08-ba5a-32d9c6b2c5a1&access_token=&referer=https%3A%2F%2Fwww.nichigi.co.jp%2Fen%2Fen_downloadform%2Fen_data.html, catalog dedicated to temperature indicator materials). The given catalogue discloses an indicator label having a layered structure consisting of an insulating lining, an adhesive layer, a non-color-changing painted base, an adhesive, a heat-activated composition and a protective polymer film. The adhesive layer covering the back surface of the temperature indicator is heat-resistant, which allows the device to be attached to the surface with the measured temperature immediately after removing the insulating pad. The protective polymer film that covers the temperature-detecting element is heat-resistant and protects it from water, chemicals, oils and environmental influences. High accuracy of temperature determination is achieved by using the effect of changing the color of purified stable pigment when it reaches its melting point. Moreover, the indicator is irreversible and does not return to its original color after operation.

However, the manufacturer warns of the need to attach these indicator labels only to a flat surface, since fixing them to curved surfaces or corners may result in inaccurate operation of the device on page 2 of the catalogue. This indicates insufficient flexibility of both the label base and the layer of heat-sensitive material, the attachment of which to surfaces of complex shape can lead to the formation of cracks and detachment of the composition layer from the base, as well as uneven heating of the heat-sensitive material, which will also reduce the accuracy of overheating registration; For this reason, such devices cannot be widely used to detect surface overheating and control the temperature of equipment elements, including electrical equipment, that have complex geometry and a small radius of curvature.

The patent is aimed at creating the device for recording the excess of threshold temperature, made in the form of a label that is elastic, flexible, and durable, in order to reliably record the excess of temperature of the surface of various shapes, including elements of electrical equipment.

### Terms and Definitions Used in This Patent

The term “label” means an arbitrarily-shaped element, the back side of which is covered with glue protected by an insulating film, and after removing the film, the adhesive layer provides the necessary adhesion to the surface. The term “adhesion” is the bonding of surfaces of dissimilar bodies. In relation to the present patent, in particular, the adhesion (FINAT TM1, after 24 hours, stainless steel) may be no less than 10N/25 mm, as determined experimentally.

The terms “elastic base” and “elastic protective film” characterize the base or protective film material, which refers to materials with the ability to change their shape without breaking under external influence.

The term “heat-sensitive material” means a material that becomes more transparent to at least part of visible light relative to its original state when heated above a threshold temperature, and does not return to its original state upon subsequent cooling. The heat-sensitive material may consist, for example, of an individual organic compound or a salt of an organic acid that undergoes a phase transition upon reaching a threshold temperature, or of a mixture of substances. Moreover, the heat-sensitive material may additionally include a binder, represented, for example, by organic resins, for better adhesion of the heat-sensitive material to the flexible base, and other additives.

The term “threshold temperature” or “threshold temperature value” refers to the numerical temperature value at which an irreversible change in the properties of the heat-sensitive material occurs. The accuracy of recording the excess of the threshold temperature is 5 °C in the specified patent.

The term “accuracy of recording the excess of the threshold temperature” means the following:
1. Until the device reaches a temperature equal to the threshold temperature of the corresponding heat-sensitive material minus the value of the declared accuracy, there is no change in the transparency of the corresponding heat-sensitive material and the appearance of the device.
2. At a temperature equal to or greater than the threshold temperature of the corresponding heat-sensitive material plus the value of the declared accuracy, the corresponding heat-sensitive material is transparent and the device has a different appearance from the original one.
3. The exact value of the phase transition of the heat-sensitive component is within the declared range and is not further established. The accuracy of recording the excess of the threshold temperature determined by this patent is 5 °C.

“Phase transition” is the transition of a substance from one thermodynamic phase to another when external conditions change. In the context of this patent, the phase transition is “melting” and means the transition of a material from a solid state to a liquid one when the temperature increases to or above the melting point of the composition.

The term “operation” is applied to the heat-sensitive material that has undergone a phase transition with an increase in transparency in the present patent. The device in which the heat-sensitive material has changed transparency is designated as “operated”.

“Defect” is non-compliance of the object with the requirements established by the documentation for at least one indicator.

“Fire resistance” refers to the ability of a material to resist combustion when exposed to an ignition source.

The term “electrical strength” defines the property of a given device to withstand the electrical voltage applied to it. In other words, electrical strength is the minimum electric field strength at which the device breaks down.

The term “dielectric” means the property of a given device to withstand the electrical voltage applied to it, while the minimum electric field strength at which the device breaks down exceeds the electrical strength of air under normal conditions with a layer thickness of 1 cm, which is 3 kV/mm.

The term “complex geometry surface” means any curved surface containing bends, fractures and other non-linear elements with a minimum bending radius of 2 mm or more. In this patent, a cylindrical surface with longitudinal waves with a radius of curvature of an individual bending element of R=2 mm is considered as a model surface of complex geometry.

The term “radius of curvature” of curved and cylindrical surfaces refers to the maximum radius of a circular arc that best fits these surfaces. In relation to this patent, “small radius of curvature” means a radius of curvature of 2 mm or more.

The term “cylindrical surface” refers to a developable closed or open ruled surface formed by the parallel movement of a straight line along some curvilinear guide.

The term “elasticity” reveals the ability of a material, when bent around a cylindrical surface, to repeat its shape without loss of functional properties. The term “tensile/compressive elasticity” refers to the retention of the functional properties of a material when a force is applied in any direction in a plane parallel to the plane of the material, as well as after the force is removed.

“Elongation before breaking” means the numerical value of the elongation of a product or its parts when stretched, above which its physical integrity is violated and rupture occurs. The value is expressed as a percentage, indicating how much the linear dimensions of the material increase when it is stretched relative to the corresponding original dimensions.

In this patent, the term “glazing” is used, denoting the process of forming a uniform layer of one thermodynamic phase around a particle of another thermodynamic phase.

### The Essence of the Patent

This patent was created to improve the safety of equipment operation, including energy equipment, through accurate and reliable recording of defects associated with exceeding the threshold temperature value by the surfaces and elements of this equipment.

The objective of this patent is to create a device that ensures the possibility for reliably and accurately recording the excess of threshold temperature when placed on surfaces, including those with complex geometry with a minimum radius of curvature of 2 mm, and made of materials whose linear dimensions can increase within 10%, and does not lose its functional properties, including the accuracy of recording the excess of threshold temperature, when adhered to the specified surfaces.

The technical result of the specified patent consists in increasing the safety of operation of various equipment, including electrical equipment, due to the possibility of tightly fitting the device for recording the excess of threshold temperatures to surfaces made of various materials, with complex geometry with a minimum radius of curvature of 2 mm, and made of materials whose linear dimensions can increase within 10%, without loss of accuracy in recording the excess of threshold temperature, including to current-conducting elements of electrical equipment.

The technical result is achieved by the device for recording the excess of threshold temperature, which is an elastic label having a layered structure, including:
an adhesive layer;
a colored elastic base containing at least 5 mass % of halogen atoms, onto which information is applied, including the numerical value of the recorded threshold temperature;
a heat-sensitive material applied to a section of the front surface of the base, made with the ability of visually recording overheating due to an irreversible change in transparency relative to the original state when heated in the range of ±5 °C from the threshold temperature indicated on the label, and including a solid organic substance with a structural fragment of ₙH₍₂ₙ₊₁₎, where n≥5;
an elastic protective film, transparent to at least part of visible light, covering the front surface of the base and the heat-sensitive material,
   wherein the device is designed with the ability to maintain the function of visually recording overheating in the range of ±5 °C from the threshold temperature indicated on the label after its mounting on a cylindrical surface, the minimum radius of curvature of which is 2 mm, as well as after longitudinal and transverse stretching by 10% relative to the original size.

The polymer material of the base and protective film is selected in such a way as to ensure the simultaneous fulfillment of the following criteria: flexibility and elasticity, necessary for tight fit of the device to surfaces of complex geometry while maintaining the ability to record overheating with the stated accuracy; the necessary adhesion both to the controlled surface itself and to the heat-sensitive material, mandatory for reliable fixation of the device, preventing its adhesion off during thermal expansion of the controlled surface or vibration and maintaining the ability to record the excess of temperature; as well as resistance to ignition.

The most suitable materials for this purpose are halogen-containing polymers, primarily polyvinyl chloride. Polymer materials in whose structure halogen atoms are present have some of the highest flexibility and elasticity indices among known polymers. The introduction of halogen atoms into the monomers used as feedstock for polymerization breaks their symmetry and creates one or more chiral centers. Polymerization or polycondensation of such monomers, either with each other or with other halogen-containing or halogen-free monomers, results in the formation of polymer chains with a large number of stereocenters. Regular polymers obtained from non-halogenated monomers without chiral centers tend to form crystalline structures, which reduces their elasticity, while the large number of diastereomers arising from halogenation of monomers imparts stereochemical disorder to halogen-containing polymers, which prevents crystallization. Thus, halogen-containing polymeric materials have high elasticity and flexibility due to the peculiarities of their chemical structure, caused by the presence of halogen atoms in the structure of polymers. In addition, halogen-containing materials have good adhesion and low flammability, which serves as an additional provision for safe operation of the specified device and the equipment on which it is placed.

When manufacturing temperature indicators in the form of labels, it is necessary to take into account the stretchability of some materials, as well as the thermal expansion of the materials (their TEC—thermal expansion coefficient) to which the label will be adhered. An increase in the temperature of the surface to which the device is glued will be accompanied by thermal expansion of the surface material, therefore, if the device does not have elasticity for stretching, the label will adhere off and become deformed, which will lead to a decrease in the reliability of recording the temperature increase. This is especially relevant in the energy sector, where the vast majority of materials used have significant thermal expansion coefficients, and dynamic connections are also used to prevent the negative effects of thermal expansion of materials. These types of connections also require temperature control, which can only be carried out using elastic labels that can easily deform when the shape and size of the equipment elements on which they are placed change.

Therefore, it is necessary that the device (in particular, made in the form of a label) has not only flexibility and elasticity in bending, but also elasticity in stretching, i.e. when stretching the label in any direction in a plane parallel to the base, there is a corresponding increase in its linear dimensions while maintaining the necessary functional properties.

The use of a heat-sensitive material made with the ability of visually recording overheating due to an irreversible change in transparency relative to the original state when heated in the range of ±5 °C from the threshold temperature indicated on the label, and including a solid organic substance with a structural fragment of CₙH₍₂ₙ₊₁₎, where n≥5, is associated with the following.

The use of compounds containing one or more long aliphatic hydrocarbon chains results in solid organic substance particles being formed into fibers, flakes, or flat or elongated crystals. When such a heat-sensitive material is applied to the base, the flat particles are oriented predominantly parallel to the base layer and the protective film layer, due to which the heat-sensitive material layer acquires the ability to bend and stretch/compress without deformation and loss of functional properties (FIG. 12a).

Such crystalline packing causes anisotropy of solid organic substance, as a result of which the properties of the material in the direction parallel to the surface of the base and the protective film differ from the properties of the material in the direction perpendicular to the surface of the base and the protective film. The anisotropy of the properties of a heat-sensitive material affects the strength of the material under bending and mechanical stress: application of impact in directions close to perpendicular to the surface of the base will not lead to damage to the material (A. I. Kitaigorodsky, Organic Crystal Chemistry, M., USSR Academy of Sciences, 1955). Since the flat particles of solid organic substance are oriented predominantly parallel to the base layer and the protective film layer, then during longitudinal stretching or compression of the device, the layers of particles will slide relative to each other with an increase or decrease in the size of the voids between them without destroying the microstructure of the heat-sensitive material and maintaining the integrity of its layer (FIG. 7). For this reason, stretching the layer of heat-sensitive material when placed both on a surface with a small radius of curvature and on a surface made of a material capable of stretching and having a high TEC will not lead to deformation of the layer of heat-sensitive material or its destruction, as well as the formation of cracks on it. This will additionally ensure safe operation of various equipment due to accurate and reliable recording of overheating of its surfaces.

In addition, when fixing the device for recording the excess of threshold temperature on the surface of complex geometry, including one with a curvature radius of 2 mm at insufficient elasticity of the protective film, its bending will create excess pressure (F′) on the heat-sensitive material. It is known that solid substance begin to melt or recrystallize into larger crystals with increasing pressure, especially at temperatures close to, but not reaching, the melting point (FIG. 7). Therefore, if the elasticity of the protective film is insufficient, its pressure (F<F′) on the heat-sensitive material at the bending points may lead to premature operation of the device and, as a consequence, false recording of overheating. Avoiding the occurrence of false operation allows not only the use of an elastic protective film, at the bending of which the pressure on the heat-sensitive material will be reduced (F≈F′), but also the use of an anisotropic microstructure of the heat-sensitive material, in which the formed flat particles are oriented predominantly parallel to the base layer.

Due to the peculiarity of the structure of the heat-sensitive layer, the microstructure of which contains a large amount of gas phase, when the threshold temperature is exceeded, the microstructure of the heat-sensitive material will be destroyed and, as a consequence, the gas and non-gas media will separate (FIG. 12). Since the process takes place during heating, due to thermal expansion, the total volume of the gas phase after heating will be significantly higher than the total volume of the gas phase contained in the microstructure of the heat-sensitive material before heating, as a result of which, when the threshold temperature is reached, an air bubble will form under the protective film that hermetically covers the front surface of the device. As the device cools further, the volume of the gas medium decreases to its original values and, as a consequence, the size of the bubble under the surface of the protective layer decreases. The described processes explain the need to use elastic protective films with the ability to stretch and compress in the manufacture of the device to maintain the integrity of this device when operating in a wide range of temperatures. Otherwise, if the protective film is not elastic and flexible enough, it may break when stretched or compressed, which will impair the accuracy of recording the excess of temperatures.

The accuracy of the recorded temperature threshold in the specified patent is no less than 5 °C.

Thus, the combination of such features of the formula as:
using a colored elastic base containing at least 5 mass % of halogen atoms;
applying a heat-sensitive material based on a phase transition comprising a solid organic substance with a structural fragment CₙH₍₂ₙ₊₁₎, where n≥5;
covering the front surface of the device with an elastic protective film that is transparent to at least part of visible light;
the ability to maintain the function of visually recording overheating in the range of ±5 °C from the threshold temperature indicated on the label after its mounting on a cylindrical surface, the minimum radius of curvature of which is 2 mm, as well as after longitudinal and transverse stretching by 10% relative to the original size,
   allowing you to avoid the following factors that negatively affect the safety of equipment operation, including the reliability of recording the excess of threshold temperatures:
premature operation associated with deformation of the heat-sensitive material;
peeling off of heat-sensitive material from the base, as well as the formation of cracks on its surface;
formation of an air bubble in the zone where the label peels off from the controlled surface;
uneven heating of the surface of heat-sensitive material;
break of the protective film with loss of its functional properties;
formation of microcracks on the surface of the protective film;
excess pressure created by the protective film on the heat-sensitive material.

In particular cases, the thickness of the elastic base is no more than 0.7 mm, and its elongation before breaking is no less than 10%. Also, the thickness of the elastic protective film is no more than 0.5 mm, and its elongation before breaking is no less than 33%.

Let us consider the extreme case of fixing a label to a cylindrical surface with a radius of R=2 mm (for example, small-section electric wire cores with or without insulation, steel-aluminum wires of overhead power lines, apparatus clamps, surface of coils, blades of bolted contact connections, contact lamellas, jaws of fuse contact connections, etc.). The length of the label base before fixing to a curved surface was L_{bas}., the length of the layer of heat-sensitive material was L_{t.m}., and the length of the protective film was L_{p.f}. When placed on a cylindrical surface, the bending radius of the device base will be equal to R₁=R+h₁, where h₁ is the thickness of the base, the bending radius of the heat-sensitive material will be equal to R₂=R+h₁+h₂, where h₂ is the thickness of the heat-sensitive material, and the maximum bending radius of the protective film will be equal to R₃=R+h₁+h₂+h₃, where h₃ is the thickness of the protective film. In most cases, the thickness of the adhesive layer (h₀) is so small that it can be taken as zero. Preferably, the thickness of the base is no more than 0.2 mm, the thickness of the heat-sensitive material layer is no more than 0.3 mm, and the thickness of the protective film is no more than 0.15 mm. Then, to ensure a tight fit of the device to a surface with a radius of curvature of 2 mm while maintaining adhesion, the outer surface of the base must bend on a radius of (2+0.2) mm, which is 10% greater than the radius of the cylindrical surface. In this case, the length of the outer surface of the base after gluing L′_{bas}. should also increase by 10% relative to its original length, i.e. be L′_{bas}.=1.1*L_{bas}. The outer surface of the heat-sensitive material layer must bend on a radius of (2+0.2+0.3) mm, which is 25% greater than the radius of the cylindrical surface. In this case, the length of the outer surface of the heat-sensitive material layer after gluing the label L′_{t.m.} should also increase by 25% relative to its original length, i.e. be L′_{t.m.}=1.25*L_{t.m.} The outer surface of the protective film must bend as much as possible on a radius of (2+0.2+0.3+0.15) mm, which is 33% greater than the radius of the cylindrical surface. In this case, the maximum length of the outer surface of the protective film after gluing the label L′_{p.f.} should also increase by 33% relative to its original length, i.e. be L′_{p.f.}=1.25*L_{p.f.} (see FIG. 1a, FIG. 10 and the calculation given in the description of FIG. 10). Moreover, when using thicker layers of the heat-sensitive material base and protective film, the corresponding components of the device must increase their length by up to 100%.

For this reason, it is important that the device for recording the excess of threshold temperatures after its mounting on a surface with a minimum radius of curvature of 2 mm, as well as after longitudinal and transverse stretching by 10% relative to the original size, does not lose its adhesive properties, is not damaged, does not break and fully retains its functionality with the ability to record overheating in the range of ±5 °C from the threshold temperature indicated on the label, which, in particular, is ensured by the use of a base and protective film that are flexible and elastic, as well as the ability to elongate before breaking from 10% and up to 100%.

Failure to meet these conditions will result in a significant reduction in the accuracy of recording the excess of threshold temperature.

The adhesive layer material is preferably selected to provide adhesion (FINAT TM1, after 24 hours, stainless steel) of at least 10N/25 mm, at 20 °C, which allows the component to be glued to fit tightly to the surface on which it is placed throughout its entire operation period. The specified adhesion value was determined by approximating an array of experimental data.

In a preferred variant, the device has dielectric properties, preferably has an electrical strength of at least 5 kV/mm.

In one preferred variant, the elastic base comprises polymers containing the structural unit —CH₂CHCl—, preferably polyvinyl chloride (PVC), mainly cast (obtained by pressure casting, casting) polyvinyl chloride.

The choice of such materials as a base material is based on the following. PVC and other halogen-containing films have a number of necessary properties that a material used in the electrical power industry must have to ensure the necessary operational characteristics, as well as the proper safety of operation of both the label and the equipment itself, namely:
low flammability and combustibility: in the event of emergency overheating of the surface on which the device is placed, the label itself cannot become a source of ignition, and ignition is possible only with the direct action of an open flame, after the cessation of exposure to which PVC and other halogen-containing films tend to quickly fade;
electrical strength and high dielectric properties, due to which the device does not conduct electric current, and when the label is adhered off from the controlled element with subsequent overlapping, there is no possibility of breakdown and short circuit;
flexibility and elasticity make it possible to glue the device to the surface of units of installations and electrical equipment with complex geometry, as well as sections of electric motors, bearings and other elements requiring temperature control;
tear strength and stretch resistance increase the service life of PVC and other halogen-containing films and ensure their reliable use throughout their entire service life;
non-toxicity: during long-term operation under conditions close to standard conditions, no substances harmful to humans are released.

The presence of halogen atoms in the structure of the elastic base is, among other things, due to fire safety requirements, namely the low flammability values of the device. It is known that materials containing halogen atoms in their composition have low flammability, which serves as an additional provision for safe operation of the device and the equipment on which it is placed. The ignition of the label under the influence of high temperature can lead to a fire in the electrical installation, as well as to the occurrence of an electric arc. In this case, the base can include both halogen-containing polymers and halogen-containing additives. The mass percentage content of halogen atoms in both cases is no less than 5 mass %. For halogen-containing polymers, this parameter is significantly higher and amounts, in particular, to 57-74 mass % for polyvinyl chloride, depending on the production method, and to 59% for polyvinylidene fluoride. Halogen-containing additives, which are introduced into polymer films that do not contain halogen atoms in their structure, act as antipyrenes or plasticizers and are effective even when added in low concentrations.

In addition, all halogen-containing polymers are good dielectrics and are characterized by high values of electrical strength. Additionally, the elasticity of halogen-containing polymers, especially PVC, should be noted.

The properties of the final PVC film depend on the method of its production, as well as on the presence of modifying additives—plasticizers. Plasticized PVC has high elasticity and is processed into films and other finished products in several ways. PVC films can be produced by rolling, which results in the formation of a material with elongated polymer fibres oriented predominantly along the rolling direction. This gives the films increased elasticity, flexibility and elongation at break of up to 300%, but only in the rolling direction. Extruded PVC films also have high elasticity, flexibility and strength only in the extrusion direction. Injection molded PVC films (cast or casting films) also have the advantages of the other two types of plasticized PVC, however, their properties are the same in all directions, which makes this material the most preferable for use as a base for the device of recording the excess of temperatures. In addition, pressure casting allows for the production of denser and stronger films with a smooth surface. Thus, the use of, in particular, cast PVC as a base meets all of the above requirements.

Based on the above, the transparent elastic protective film can also be made of polyvinyl chloride, preferably cast polyvinyl chloride.

It is preferable to use thinner layers of the structure, since this, in particular, has a positive effect on the flexibility and elasticity of the device, and, as a result, provides additional reliability of safe operation of both the label and the equipment itself, however, it is necessary to take into account the strength characteristics of the device, which must also meet the requirements for labels and temperature indicators in general.

Thus, in particular cases, the thickness of the elastic base may preferably be no more than 0.2 mm, the thickness of the heat-sensitive material may be no more than 0.8 mm, and the transparent elastic protective film may have a thickness of no more than 0.15 mm.

In particular cases, the heat-sensitive material in its original state has a microstructure that includes a continuous solid phase and voids filled with the gas phase, and is designed with the ability to irreversibly change its appearance upon reaching the specified threshold temperature due to the destruction of the microstructure of the heat-sensitive material, accompanied by the fusion of particles of solid organic substance, a decrease in the fraction of voids and an increase in its transparency with the development of the color of the base (see FIG. 12).

The use of a heat-sensitive material with voids makes it possible to increase the service life, to increase the reliability of overheating determination due to the impossibility of aggregation of solid particles through the gas phase and to eliminate the possibility returning the material to its original state after operation due to an irreversible change in the microstructure, which also has a positive effect on the safe operation of both the label and the equipment itself. When a heat-sensitive material containing voids is melted, an irreversible change in the original microstructure of the material occurs with a decrease in the fraction of voids in it, associated with the fusion of particles of solid organic substance and with a decrease in the area of the solid-gas phase boundaries, due to the irreversible release of gas contained in voids onto the surface and separation of gas and non-gas media. As a result, upon further cooling, the solid organic substance crystallizes without voids, thereby irreversibly changing the transparency (increasing relative to the original state) of the material for at least part of visible light, creating a visual effect of changing the appearance of the device with high contrast, which ensures high reliability of recording the excess of temperature above the specified value. Preferably, the fraction of voids of the heat-sensitive material after heating above the corresponding threshold temperature value decreases by at least 2 times relative to the original state, which further increases the contrast of the color transition of the device when the threshold temperature value is exceeded.

In addition, the presence of voids filled with the gas phase increases the ability of the heat-sensitive material to change its linear dimensions and bend, without losing the accuracy of recording the excess of threshold temperatures.

The organic substance of the solid phase of the heat-sensitive material can be selected from the group: fatty aliphatic acids containing structural fragments CₙH₍₂ₙ₊₁₎ with n≥12; salts of fatty aliphatic acids containing structural fragments CₙH₍₂ₙ₊₁₎ with n≥5; alkanes containing at least 20 carbon atoms; dialkylphosphinic acids containing structural fragments CₙH₍₂ₙ₊₁₎ with n≥5; amides of fatty aliphatic acids containing structural fragments CₙH₍₂ₙ₊₁₎ with n≥5; anhydrides of fatty aliphatic acids containing structural fragments CₙH₍₂ₙ₊₁₎ with n≥10; fatty aliphatic alcohols containing structural fragments CₙH₍₂ₙ₊₁₎ with n≥14; fatty aliphatic amines containing structural fragments CₙH₍₂ₙ₊₁₎ with n≥17; nitriles of fatty aliphatic acids containing structural fragments CₙH₍₂ₙ₊₁₎ with n≥19.

The use of organic compounds containing one or more aliphatic hydrocarbon chains CₙH₍₂ₙ₊₁₎ with n≥5 as an organic substance of the solid phase of the heat-sensitive material promotes the formation of a crystalline package in which the elongated structural fragments of linear hydrocarbons are oriented parallel to each other (A. I. Kitaigorodsky, Molecular Crystals, M.: Nauka, 1971). Due to the fact that the particles of solid organic substance are formed in the form of fibers, flakes or flat or elongated crystals, that is, they have a two-dimensional structure, the heat-sensitive material forms a special microstructure capable of bending and stretching without deformation and loss of functional properties.

Also, the use of solid organic compounds including non-polar aliphatic fragments, additionally contributes to an increase in the electrical strength values of the device as a whole, since such fatty aliphatic derivatives have good dielectric properties.

In particular cases, the organic substance of the solid phase of the heat-sensitive material is selected from the group: palmitic acid, stearic acid, behenic acid, tetracosane, erucamide, stearyl alcohol, cetyl alcohol, polyethylene, wax, paraffin, salts of saturated fatty carboxylic acids of rare earth metals, in particular lanthanum, yttrium, ytterbium, scandium.

The content of solid organic substance in the heat-sensitive material is no less than 50 wt. %, preferably 50-90 wt. %, most preferably 70 wt. %. It has been experimentally established that an increase in the mass content of the organic substance of the solid phase above 50 mass %, as well as the use of an individual solid organic substance as a heat-sensitive material, leads to easy separation of individual particles of the heat-sensitive layer with a general preservation of the external appearance due to the low adhesion of the solid parts in relation to each other, prevents cracking of the material after mounting the device on a surface with a small radius of curvature, and damage to the integrity of the layer during longitudinal and/or transverse stretching of the device. It was also shown that increasing the content of transparent binder above 50 wt. % leads to the need to use a thicker layer of heat-sensitive material, since the low concentration of solid organic substance particles (below 50 wt. %) does not ensure the non-transparency of a layer of heat-sensitive material with a thickness of no more than 0.8 mm.

In particular cases, the microstructure of the heat-sensitive material additionally contains a polymer binder that is transparent to at least part of visible light, the phase transition temperature of which is higher than the phase transition temperature of the solid organic substance. In this case, the heat-sensitive material contains the “solid-solid-gas” phase boundaries; during melting, an irreversible change in the microstructure of the material also occurs, as a result of which the number of voids decreases relative to the original state due to the release of the gas contained in them to the surface of the material and separation of gas and non-gas media occurs, as a result of which a decrease in the contact area of the solid phase and voids is observed, i.e. reducing the area of phase boundaries.

Preferably, the polymeric binder is present in the heat-sensitive material in an amount of 1-30 wt. %. In particular cases, the polymer binder covers each individual structural particle of the solid organic substance, providing it with “glazing”. The binder is selected to ensure wettability, but not dissolution, of the particles of solid organic substance in the polymeric binder. Due to this, when “glazing” grains, crystals, fibers, flakes or conglomerates of these particles, additional gas capture occurs, in the environment of which a heat-sensitive material is formed, and its distribution between the “glazed” particles of solid organic substance by the binder.

In preferred variants, the heat-sensitive material is made with the ability to change transparency when heated to a temperature exceeding the threshold temperature for no more than 5 seconds. This is due to the fact that the stated thickness of the heat-sensitive material layer and its structure in combination with the declared thickness of the device base allows heating the heat-sensitive material when short-term overheating occurs during peak load periods and completely converting it into a melt with the “non-transparent-transparent” color transition in less than 5 seconds, and also provides the necessary heat transfer during air cooling of operating devices.

The threshold temperature can be selected from the range of 50-210 °C, primarily 50 °C, 55 °C, 60 °C, 70 °C, 80 °C, 90 °C, 100 °C, 110 °C, 120 °C, 130 °C, 140 °C, 150 °C. Based on the threshold temperature value selected for recording, the applied heat-sensitive material is selected in such a way that the solid organic substance included in its composition has a melting point that differs from the threshold temperature by no more than 5 °C.

In particular variants, the coloring of the elastic base or the inscription is made with the ability to carry out marking of elements of electrical equipment or color marking of phases. In particular, the inscription containing color, letter, digital or alphanumeric marking information may be applied to the front surface of its base. In one case, the inscriptions on the elastic base contain information about the date of completion of operation of the device. The elastic base can also have a color that corresponds to the established rules for marking elements of power equipment. The above-listed features serve to give the device for recording the excess of threshold temperature the properties of the marking elements of electrical equipment, which also additionally ensures the safe operation of the equipment on which such devices are placed, due to the following. In the case of contact connections, wires or units of electrical equipment, we are talking about small surfaces that, on the one hand, require marking, and on the other hand, temperature control. However, the use of marking devices and devices for recording the excess of temperature separately is often not possible due to the insufficient area of the controlled surface. Using only a temperature indication device without marking can lead to incorrect identification of the defective unit, as well as to an increase in detection time. Thus, a device that combines the properties of a marking device, as well as the properties of temperature indicators, will also have a positive effect on the safe operation of various equipment.

In particular cases, the area of the heat-sensitive material may occupy from 3 to 97% of the area of the front surface of the label, preferably at least 30% of the area of the front surface of the label. Preferably, the surface area of the base coated with the heat-sensitive material is no less than 100 mm².

Preferably, the device is made with the ability to record overheating of individual sections of the surface by changing the transparency of only that part of the heat-sensitive material that was heated above the threshold temperature, and maintaining the original transparency of that part of the heat-sensitive material that was not heated above the threshold temperature.

In some variants, at least 70% of the base area covered with the heat-sensitive material is painted black, and when the corresponding threshold temperature is reached with the stated accuracy, a visual color transition of part of the surface of the device from white to black occurs, that is, the heat-sensitive material in a non-transparent state is white.

In order to increase the visibility of both the device itself and the fact of its operation, on equipment elements, including those difficult to inspect due to the large size of the installations, the location of the installations outdoors or due to the inspection being carried out in bad weather conditions and in conditions of insufficient visibility, at night using a flashlight, as well as for inspecting equipment without artificial lighting and windows, and, as a consequence, to further increase the safety of equipment operation, the base may have reflective properties or may be painted using a substance that has luminescent properties.

In particular cases, the base can be colored using a substance made with the ability to irreversibly change color when heated.

The use of substances in the painting of the base that are capable of irreversibly changing colour when heated to a temperature below the threshold temperature of the main heat-sensitive material, for example, by 10-30 °C, allows informing personnel about the risk of an emergency defect occurring in the future, and thus ensures the possibility of preventing it, with the proper response of the personnel responsible for this equipment. Thus, the operation of such a substance, in the absence of operation of the main heat-sensitive material, indicates the presence of overheating of the equipment, which has not reached the maximum permissible values corresponding to the threshold temperature of the main heat-sensitive material, and the need to inspect it in order to identify and eliminate malfunctions that could subsequently lead to the development of an emergency defect. Thus, the presence of a substance made with the ability to irreversibly change color when heated to a temperature below the threshold temperature of the main heat-sensitive material, in particular by 10-30 °C, additionally increases the safe operation of both the specified device and the equipment as a whole.

Also, the base can be colored using a substance made with the ability to irreversibly change color when heated. For example, the front surface may be coated with a layer of heat sensitive paint with the above-mentioned properties.

The presence of a substance made with the ability to reversibly change color when heated makes it possible to inform personnel not only about the excess of threshold temperature value, but also about overheating at the time of inspection. The operation of such substance at the time of inspection indicates that the equipment is currently in emergency mode and may be a source of increased danger. Thus, the presence of a substance made with the ability to irreversibly change color when heated additionally increases the safe operation of both the specified device and the equipment as a whole.

### BRIEF DESCRIPTION OF DRAWINGS

The patent will be better understood from a non-limiting description given with reference to the accompanying drawings, which show:

FIG. 1—Example of placing the device for recording the excess of threshold temperature on an element of complex geometry (cylindrical surface)—1a—sectional view, 1b—side view, 1c—sectional view, example of placing the device that does not have the necessary flexibility and elasticity on an element of complex geometry (cylindrical surface).

FIG. 2—Example of longitudinally placing “in a pinch”, sectional view, 2a—the specified device, 2b—the device that does not have the necessary flexibility and elasticity.

FIG. 3—Example of transversely placing the specified device on an element of complex geometry (concave surface).

FIG. 4—Layered structure of the specified device for recording the excess of threshold temperatures—4a, with black paint applied to the front surface of the elastic reflective base in the zone of the heat-sensitive material—4b.

FIG. 5—Example of placing the device for recording the excess of threshold temperature, which does not have the necessary flexibility and elasticity, on a surface changing its linear dimensions, 5a—before stretching, 5b—after stretching.

FIG. 6—Device for recording the excess of threshold temperature with additional coloring in the zone of the heat-sensitive material: 6a—original appearance of the label, 6b—operated label after exceeding the threshold temperature.

FIG. 7—Structure of the heat-sensitive material containing a continuous solid phase and voids filled with the gas phase, 7a—before stretching, 7b—after stretching, when applied to a cylindrical surface.

FIG. 8—Device for recording the excess of threshold temperature with an indication of the end of service life.

FIG. 9—Device for recording the excess of threshold temperature, in which the front surface of the base is painted using a substance made with the ability to reversibly change color when heated above a threshold temperature value, 9a—original appearance of the device, top view, 9b—fully operated label at the moment of exceeding the threshold temperature, as well as exceeding the threshold temperature value of the substance that reversibly changes color when heated, top view, 9c—fully operated label after cooling, top view, 9d—layered structure.

FIG. 10—Layered structure of a part of the device for recording the excess of threshold temperature, 10a—original appearance, 10b—after adhesion to a curved surface.

FIG. 11—Top view of the device for recording the excess of threshold temperature: 11a—original appearance of the label, 11b—partially operated label after heating above the threshold temperature only in the heated area, while maintaining the original state of the rest area of this zone.

FIG. 12—Microstructure of the heat-sensitive material with particles of solid organic substance in the form of flakes and their conglomerates before operating (12a) and after operating (12b).

FIG. 13—Example of placing the device for recording the excess of threshold temperature on a wavy surface, 13a—layered structure, 13b—top view in the original state, 13c—top view after operating the device.

FIG. 14—Device for recording the excess of threshold temperature, in which the front surface of the base is painted using a substance made with the ability to irreversibly change color when heated above a threshold temperature value, 14a—original appearance of the device, top view, 14b—partially operated label after exceeding the threshold temperature of the substance that irreversibly changes color when heated, top view, 14c—fully operated label after exceeding the threshold temperature of the heat-sensitive material, top view, 14d—label after cooling, top view, 14e—layered structure.

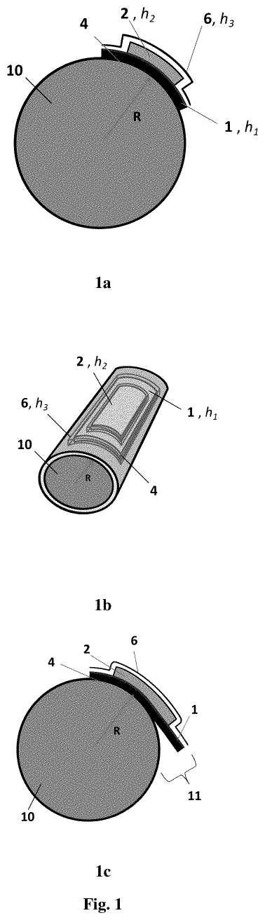

FIG. 1 shows an example of placing the device for recording the excess of threshold temperature on an element of complex geometry 10 with a radius of curvature R, which is a label having a layered structure including an adhesive layer 4 with a thickness h₀, an elastic base 1, with a thickness h₁, and a heat-sensitive material 2 applied to its front side, with a thickness h₂, the label is covered with a transparent elastic protective film 6 with a thickness h₃. FIG. 1a shows a particular variant of the device with a black elastic base, sectional view, FIG. 1b shows a particular variant of the device with a yellow elastic base, general view, FIG. 1c shows a particular variant of the device with a black elastic base, sectional view, wherein the device does not have the necessary flexibility and elasticity and as a result adhere off from the surface 10 with the formation of a gap 11. If the surface has a radius of curvature R, then the elastic base 1 has a bending radius R₁=R+h₀, the heat-sensitive material 2 has a bending radius R₂=R+h₀+h₁, and the transparent elastic protective layer 6 has an average bending radius R₃=R+h₀+h₁+h₂.

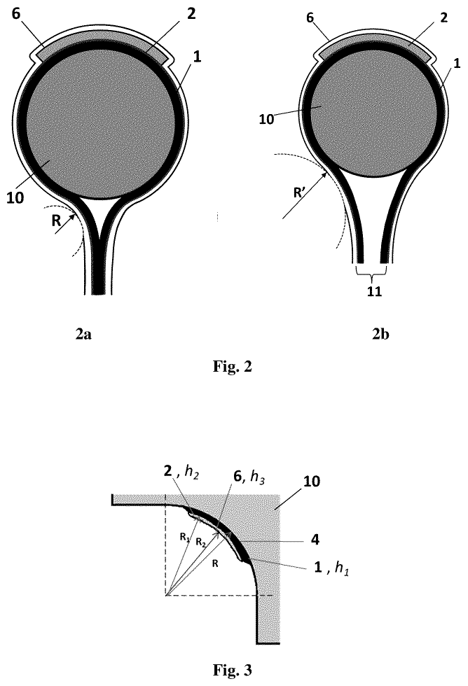

FIG. 2 shows a cross-sectional view of the “pinch” fastening of the device for recording the excess of threshold temperature on a cylindrical surface 10, which is a label having a layered structure including an elastic base 1 and a heat-sensitive material 2 applied to its front side; the label is covered with a transparent elastic protective film 6. FIG. 2a shows the specified device that has a bending radius R=2 mm or more at the fixing “pinch” point, which is as close as possible to the cylindrical surface and experiences the maximum load to hold the label in the fixed state. FIG. 2b shows the device that does not have the necessary flexibility and elasticity and has a bending radius R′ that is many times greater than the corresponding bending radius R of the specified device (R′>>R), at the fixing “pinch” point, which is as close as possible to the cylindrical surface. In this case, tight and reliable fastening of the device in FIG. 2b to the cylindrical surface 10 is not ensured and, as a consequence, a gap 11 is formed.

FIG. 3 shows an example of placing the device for recording the excess of threshold temperature with three heat-sensitive materials on an element of complex geometry (concave surface) 10 with a radius of curvature R, which is a label having a layered structure including an adhesive layer 4 with a thickness h₀, an elastic base 1, with a thickness h₁, and a heat-sensitive material 2 applied to its front side, with a thickness h₂, the label is covered with a transparent elastic protective film 6 with a thickness h₃. In this case, the elastic base has a bending radius R₁=R−h₀, and the transparent elastic protective layer has an average bending radius R₂=R−h₀−h₁−h₂.

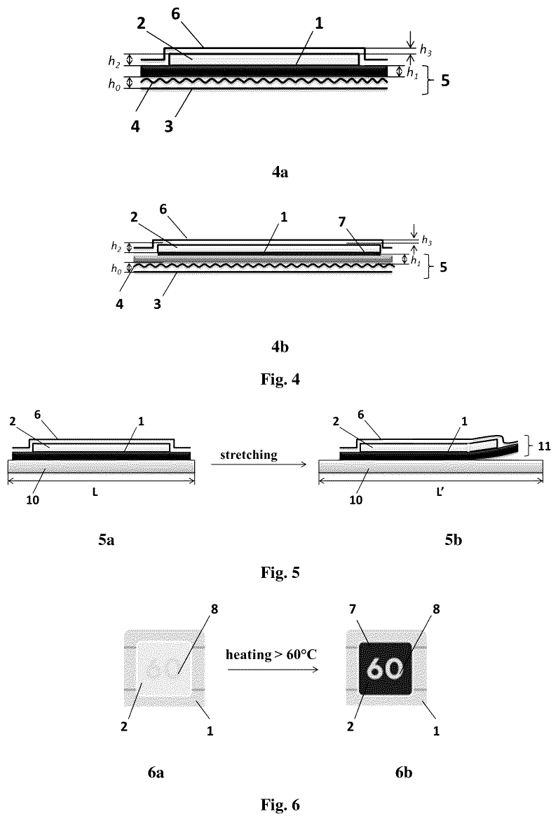

FIG. 4a shows the layered structure of the device for recording the excess of threshold temperature, which is a label having a layered structure 5 including an insulating film 3, an adhesive layer 4 with a thickness h₀, an elastic base 1, with a thickness h₁, and a heat-sensitive material 2 applied to its front side, with a thickness h₂, the label is covered with a transparent elastic protective film 6 with a thickness h₃. FIG. 4a shows a particular variant with an elastic base in black.

FIG. 4b shows the layered structure of the device for recording the excess of threshold temperature, which is a label having a layered structure 5, including an insulating film 3, an adhesive layer 4 with a thickness h₀, an elastic base 1, with a thickness h₁, and having reflective properties, wherein the front surface of the base in the zone of the heat-sensitive material is covered with paint 7, in a particular case, black, and a heat-sensitive material 2 applied to its front side, with a thickness h₂, the label is covered with a transparent elastic protective film 6 with a thickness h₃.

FIG. 5 shows the device that is a base 1 with a heat-sensitive material 2 applied to its front surface and covered with a protective film 6, while the device does not have the necessary flexibility and elasticity and is placed on a surface 10 that changes its linear dimensions. FIG. 5a shows the presented device that is tightly fixed to the surface 10 of length L until it is stretched; FIG. 5b shows the presented device that begins to adhere off from the surface 10, forming a gap 11 as a result of stretching the surface to length L′>L.

FIG. 6 shows the front side of the device for recording the excess of threshold temperature, which is a label having a layered structure including an elastic base 1 and a heat-sensitive material 2 applied to its front side: in the original state before heating (a) and after heating to the threshold temperature of the heat-sensitive material (b). FIG. 6 shows a particular variant of the device with an inscription indicating the recorded threshold temperature 8, located on an elastic base in the zone of the heat-sensitive material, the elastic base 1 is yellow and painted black 7 in the zone of the heat-sensitive material.

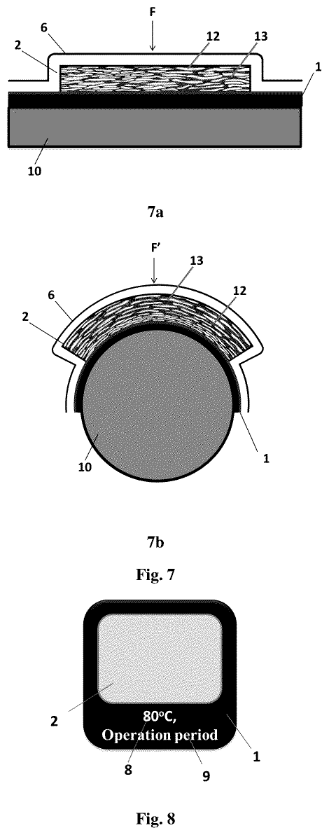

FIG. 7 shows the layered structure of a part of the device for recording the excess of threshold temperatures, placed on a flat surface 10(a) and on an element of complex geometry 10(b), which is a label having a layered structure including an elastic base 1, a heat-sensitive materials 2 applied to its front side, having a microstructure including a continuous solid phase of organic substance 12 and voids 13 filled with the gas phase.

FIG. 8 shows the front side of the device for recording the excess of threshold temperature, which is a label having a layered structure including an elastic base 1 and a heat-sensitive material 2 applied to its front side, while an inscription containing an indication of the recorded temperature 8 and the end of service life 9 is applied to the front side of the elastic base free from heat-sensitive material. FIG. 8 shows a particular variant with an elastic base painted black.

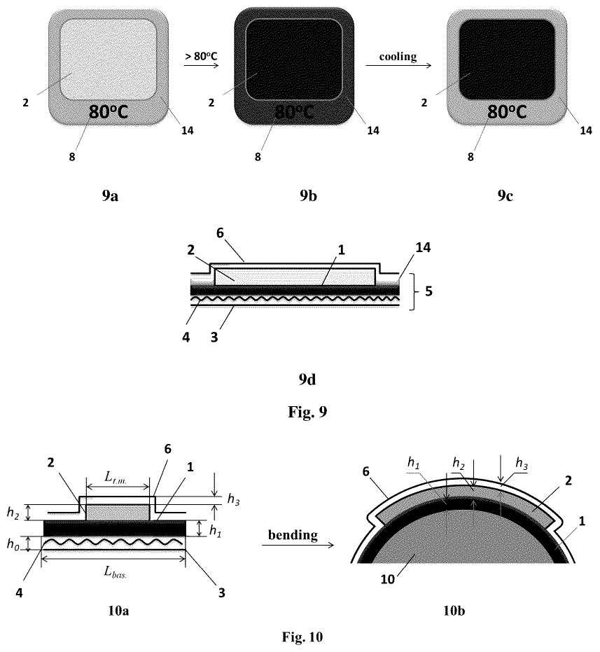

FIG. 9a-c shows the front side of the device for recording the excess of threshold temperature, which is a label having a layered structure including an elastic base 1, additionally containing a substance 14 that reversibly changes color when heated, and a heat-sensitive material 2 applied to its front side: in the original state before heating (a), after heating to the threshold temperature of the heat-sensitive material 2 and the substance 14 that reversibly changes color when heated (b), and after further cooling to a temperature below the threshold temperature of the heat-sensitive material 2 and the substance 14 that reversibly changes color when heated (c). FIG. 9d shows the layered structure of the device for recording the excess of threshold temperature, which is a label having a layered structure 5 including an insulating film 3, an adhesive layer 4, an elastic base 1, painted using a substance 14 that reversibly changes color when heated, wherein, in a particular case, the elastic base is painted black and a heat-sensitive material 2 is applied to its front side, the label is covered with a transparent elastic protective film 6. FIG. 9 shows a particular variant of the device with an inscription indicating the recorded threshold temperature 8, located on an elastic base in the zone free from heat-sensitive material 2.

FIG. 10 shows the layered structure of a part of the device for recording the excess of threshold temperature before (a) and after (b) placing on an element of complex geometry 10 with a radius of curvature R, which is a label having a layered structure including an adhesive layer 4 with a thickness h₀, an elastic base 1, with a thickness h₁, and a heat-sensitive material 2 applied to its front side, with a thickness h2, the label is covered with a transparent elastic protective film 6 with a thickness h₃. The length of the label base before fixing to the curved surface was L_{bas}., the length of the layer of heat-sensitive material was L_{t.m.}, and the length of the protective film was L_{p.f}. If the surface 10 has a radius of curvature R, then the elastic base 1 has a bending radius R₁=R+h₀, the heat-sensitive material 2 has a bending radius R₂=R+h₀+h₁, and the transparent elastic protective layer 6 has an average bending radius R₃=R+h₀+h₁+h₂. Then, when the device fits tightly to a surface with a radius of curvature R, the length of the outer surface of the base after gluing L′_{bas}.=L_{bas}.*R₁/R, the length of the outer surface of the layer of heat-sensitive material after gluing the label L′_{t.m.}=L_{t.m.}*R₂/R, the maximum length of the outer surface of the protective film after gluing the label L′_{p.f.}=L_{p.f.}*R₃/R.

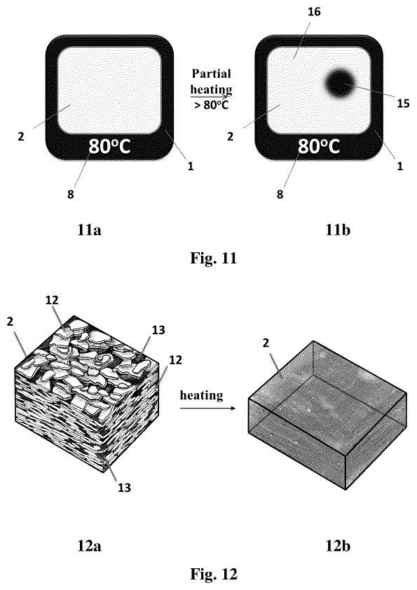

FIG. 11 shows the front side of the device for recording the excess of threshold temperature, which is a label including an elastic base 1 and a heat-sensitive material 2 applied to its front side, before heating (a) and after partial heating (b) of the zone of the heat-sensitive material, as a result of which the transparency of the given material changes only in the heated region 15, while maintaining the original state of the rest area 16 of this zone.

FIG. 12 shows the microstructure of the heat-sensitive material 2 with particles of solid organic substance 12, made in the form of flakes and their conglomerates, and voids 13 before heating (12a) and the microstructure of the heat-sensitive material 2 with a reduced fraction of voids and with an increased apparent density and with particles that have undergone fusion and lost their original shape, after heating above the threshold temperature value (12b).

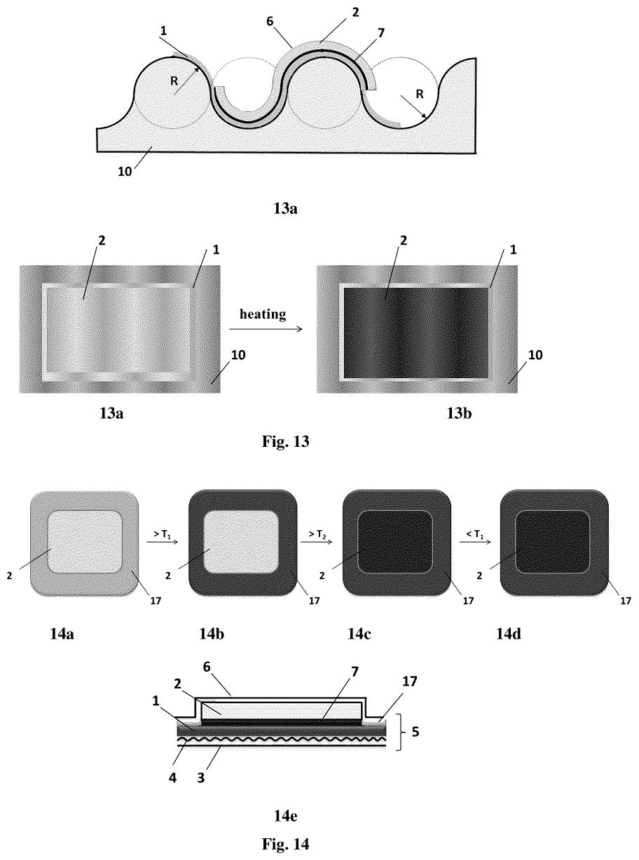

FIG. 13a shows the layered structure of the device for recording the excess of threshold temperature when it is placed on a wavy surface with a radius of curvature of an individual bending element R, wherein the device is a label having a layered structure including an elastic base 1, black paint 7 applied to its front side, a heat-sensitive material 2 applied to the paint and a transparent elastic protective film 6 covering the front side of the label. FIG. 13b shows a top view of the device for recording the excess of threshold temperature in the original state, in which the heat-sensitive material 2 is white; FIG. 13c shows a top view of the device after exceeding the threshold temperature, accompanied by an irreversible change in the transparency of the heat-sensitive material 2 relative to the original state and the development of the color of the base under it.

FIG. 14a-d shows the front side of the device for recording the excess of threshold temperature, which is a label having a layered structure including an elastic base 1, additionally containing a substance 17 that irreversibly changes color when heated, and a heat-sensitive material 2 applied to its front side: in the original state before heating (a), after heating to the threshold temperature of the substance 17 that irreversibly changes color when heated (T₁) (b), after heating to the threshold temperature of the heat-sensitive material 2 (T₂) (c) and after further cooling to a temperature below the threshold temperature of the substance 17 that irreversibly changes color when heated (d). FIG. 14e shows the layered structure of the device for recording the excess of threshold temperature, which is a label having a layered structure 5 including an insulating film 3, an adhesive layer 4, an elastic base 1, painted using a substance 17 that irreversibly changes color when heated, wherein, in a particular case, the elastic base is painted red, a heat-sensitive material 2 is applied to its front side, and the front surface of the base in the zone of the heat-sensitive material is covered with paint 7, in a particular case, black, the label is covered with a transparent elastic protective film 6.

### Implementation of the Patent

### General Technology of Manufacturing the Device

Acrylic adhesives, styrene adhesives, and polyurethane adhesives, in particular, can be used as an adhesive layer. The specified adhesives provide adhesion of more than 10N/25 mm to stainless steel at 20 °C, measured by the FINAT TM1 method after 24 hours. Below we will consider options for manufacturing and using the specified device using acrylic adhesive as an example.

Halogen-containing polymer bases containing, in particular, vinyl chloride copolymers, namely: copolymer C-15 (copolymer of vinyl chloride and vinyl acetate), copolymer VHVD-40 (copolymer of vinyl chloride and vinylidene chloride), polyvinyl chloride (PVC) films and films made of cast PVC, polyvinylidene fluoride films PVDF, films made of fluoroplast M-40, as well as polyester films with additives of 6.5% hexabromocyclododecane or polyester films modified with 15% trichloroisopropyl phosphate, preferably with a thickness of no more than 0.7 mm, can be used as an elastic base for the specified device.

The above films provide a minimum bending radius of 2 mm or more, elongation at break from 10% to 100%, have dielectric properties and are resistant to fire, the ability to longitudinally and transversely stretch by 10% relative to the original size, and can also be installed on a surface with a minimum radius of curvature of 2 mm.

The base thickness of no more than 0.7 mm ensures the operation speed of each of the heat-sensitive materials of less than 5 seconds when heated above the threshold temperature corresponding to each composition, which also increases the safe operation of the controlled equipment, since it allows heating the corresponding heat-sensitive material when short-term overheating occurs during the peak load period and completely converting it into a melt with the “non-transparent-transparent” color transition and the development of the color of the base under it within no more than 5 seconds, and also ensures the necessary heat transfer during air cooling of the operating devices.

In some variants, the base may have reflective properties or may be painted using a substance that has luminescent properties for increasing the visibility of both the device itself and the fact of its operation, which serves to further increase the safety of equipment operation.

In particular cases, the base can be colored using a substance made with the ability to irreversibly change color when heated. The presence of an additional substance made with the ability to irreversibly change color when heated to a temperature below the threshold temperature of the main heat-sensitive material, in particular by 10-30 °C, makes it possible to detect overheating of equipment that has not reached the maximum permissible values, and, as a result, to prevent the occurrence of an emergency defect.

Also, the base can be colored using a substance made with the ability to irreversibly change color when heated. For example, the front surface may be coated with a layer of heat sensitive paint with the above-mentioned properties. The presence of a substance made with the ability to reversibly change color when heated makes it possible to inform personnel not only about the excess of threshold temperature value, but also about overheating at the time of inspection.

Halogen-containing polymers, in particular PVC films, or polyurethane films modified with 15% trichloroisopropyl phosphate can also be used as a protective film. However, it must be taken into account that if they are used for protective film, they must be transparent to at least part of visible light.

### Preparation of Heat-Sensitive Material

An organic substance whose structure includes fragments CₙH₍₂ₙ₊₁₎, where n≥5, for example, palmitic acid, stearic acid, behenic acid, tetracosane, erucamide, stearyl alcohol, cetyl alcohol, polyethylene, wax, paraffin, salts of saturated fatty carboxylic acids of rare earth metals, in particular lanthanum, yttrium, ytterbium, scandium, etc., or a mixture thereof with a melting point that differs from the corresponding threshold temperatures indicated on the label by no more than 5 °C, was ground to a size of 2-3 microns in a ball mill, diluent or binder solution in diluent was successively added and mixed until a homogeneous mass was obtained. For example, water, methanol, ethanol, isopropanol, ethylene glycol, ethylene glycol monomethyl ether, acetonitrile, etc., or mixtures thereof can be used as a diluent. The suspension was used for application immediately after receipt.

In preferred variants, the content of solid organic substance in the heat-sensitive material is 70 wt. %.

In particular cases, the heat-sensitive material additionally contains a polymer binder that is transparent to at least part of visible light, the phase transition temperature of which is higher than the phase transition temperature of the solid organic substance. Preferably, the polymeric binder is present in the heat-sensitive material in an amount of 1-30 wt. %.

In particular cases, the transparent polymer binder is selected from phenol formaldehyde resin, butyl methacrylic resin, melamine formaldehyde resin, polyvinyl butyral, polybutyl methacrylate, polyisobutyl methacrylate, polybutyl acrylate, phenoxy resin, polystyrene acrylic emulsion, polyolefin, polystyrene, polyacrylate, polyethersulfone, polyethylene, polypropylene, polystyrene, polyvinylidene fluoride, polytetrafluoroethylene, polyethersulfone, polyisoprene, polypropylene, polybutadiene, polyisobutylene, polyvinyl acetate, polymethacrylate, ethylcellulose, polyvinyl chloride, polyvinylidene chloride, polycarbonate, polycaprolactone, polyethylene terephthalate resin, polybutylene terephthalate resin, polyamide resin, polyvinylidene fluoride, polyester, polyester resins, hydroxyethylcellulose, methylcellulose, ethylcellulose, nitrocellulose, carboxymethylcellulose, gelatin, agar-agar, casein, gum arabic, polyvinyl alcohol, polyethylene oxide or mixtures thereof.

The organic substance is selected in such a way that when the threshold temperature is reached in the range of no more than 5 °C, it melts with a visual non-transparent-transparent transition.

In various variants, the organic substance included in the composition of the heat-sensitive material is selected in such a way that the threshold temperature can be selected from the range from 50 °C to 210 °C, in particular cases, the temperature threshold is selected from the group: 50 °C, 55 °C, 60 °C, 70 °C, 80 °C, 90 °C, 100 °C, 110 °C, 120 °C, 130 °C, 140 °C, 150 °C.

An inscription with information about the threshold temperature was placed on the front side of the device. In particular cases, in addition to the threshold temperature, information about the date of completion of operation was also indicated. In one of the variants, the markings comprising color, letter, digital or alphanumeric marking information were applied. The heat-sensitive composition was applied using silk-screen printing in several layers until a uniform non-transparent coating up to 0.8 mm thick was obtained. After each application, the layer was dried in air, either in a thermostated chamber at a temperature no higher than the threshold temperature or in vacuum until the easy-boiling components were completely removed and the required microstructure was formed.

With this method of production, the resulting heat-sensitive material is represented by two continuous phases: solid and gas. In this case, the resulting heat-sensitive material in the original state is non-transparent to at least part of visible light, and when heated above the corresponding threshold temperature value, an irreversible change in the microstructure of the heat-sensitive material occurs, accompanied by the fusion of particles of solid organic substance, a decrease in the fraction of voids and an increase in its transparency with the development of the color of the base, and when subsequently cooled, the transparency of the heat-sensitive material does not return to its original values.

In preferred variants, the heat-sensitive material is made with the ability to record local overheating of the surface by changing the color of only that part of the heat-sensitive material that was heated above the threshold temperature, and maintaining the original color of the heat-sensitive material that was not heated above the threshold temperature.

Depending on the nature of the solid organic substance, the type of the resulting particles of solid organic substance may be grains, crystals, fibers, flakes, or conglomerates of these particles.

After applying the heat-sensitive material, the device is covered with an elastic protective film that is transparent to at least part of visible light, which protects the device from external environmental influences, humidity, UV radiation and mechanical damage, increases the service life of the device and prevents the heat-sensitive material from flowing during the phase transition. Thus, the device is made with the ability to record the excess of threshold temperature of current-conducting elements in the open air.

In a particular case, the elastic base 1 may be colored to perform additional marking of cable phases, installation wires, harnesses and other elements of electrical equipment, and the color of the base is selected in accordance with GOST 28763-90, which establishes, in particular, color marking in the field of electrical engineering. The color of the elastic base 1 does not affect the visual recording of the excess of threshold temperatures of the equipment surface, but provides the device marking necessary to improve the general safety of the equipment operation.

Also, in a particular case, a dye, including a black dye, can be applied to the flexible base in the zone of the heat-sensitive material before applying the heat-sensitive material. In one variant, at least 70% of the area of the base covered with the heat-sensitive material is painted black.

The area of the heat-sensitive material can occupy from 3 to 97% of the area of the front surface of the base, preferably at least 30% of the area of the front surface of the base, in a particular case, the area of the surface of the base covered with the heat-sensitive material is no less than 100 mm², which allows detecting operated devices from a long distance, and also allows detecting point heating of a large surface of the installations.

### The Device Works as Follows

The recording device is installed on the surface of equipment elements for which temperature control must be ensured, including elements with a radius of curvature of 2 mm or more, using an adhesive layer 4, from which an insulating film 3 is first removed, which is a label having a layered structure 5 including an adhesive layer 4, an elastic base 1, a heat-sensitive material 2 applied to its front side, which is transparent in the original state and until the moment of heating to the corresponding threshold temperature with a given accuracy, as well as a transparent protective film 6. Until the surface of the equipment located under the heat-sensitive material is heated to the threshold temperature value with the given accuracy, the heat-sensitive material 2 remains non-transparent, thereby preserving the original appearance of the device. When the threshold temperature is reached with the given accuracy, the heat-sensitive material 2 undergoes the phase transition and changes its transparency, revealing the color of the elastic base 1 under the heat-sensitive material. Upon subsequent cooling of the equipment surface, the area with the operated heat-sensitive material remains transparent and the appearance of the device does not return to its original state. The temperature threshold in the specified patent is recorded in the range of 5 °C.

The numerical threshold temperature value 8 is applied to the front side of the elastic base; in particular cases, the threshold temperature value can be applied in the zone free from the heat-sensitive material 2, but next to it, or to the base under the heat-sensitive material 2, in the latter case, after melting the heat-sensitive material, the color of the base and the numerical threshold temperature value develop.

Thus, when the surface temperature exceeds the threshold temperature, the person responsible for the equipment, without using additional devices, can record the fact of overheating of the surface of electrical equipment elements with a given accuracy by using the numerical temperature value applied to the front surface of the device.

In some variants of the patent, a “white-black” color transition is applied by using an elastic base 1, painted black 7 in the zone covered with a heat-sensitive material 2, which is white in its original state. When the threshold temperature is reached with the stated accuracy, the heat-sensitive material 2 undergoes the phase transition and becomes transparent, making the black color of the painted zone 7 visible, which leads to a color transition with the maximum possible contrast and ensures greater visibility of the operated device.

The preferred variants of the specified device are presented below, which are illustrative and do not in any way limit the scope of the requested legal protection.

### EXAMPLES

### Example 1. General Technology of Manufacturing the Device

Preparing the heat-sensitive material: 100 g of organic substance with a phase transition temperature corresponding to the threshold recording temperature in the range of 5 °C was crushed to a size of 2-3 microns, 300 g of a 3-33% solution of a binder in water, methanol, ethanol, isopropanol, ethylene glycol, ethylene glycol monomethyl ether, acetonitrile or their mixtures were successively added and mixed until a homogeneous mass was obtained. The suspension was immediately used to apply the composition.

For the examples, as one of the possible variants for the device, halogen-containing polymer films of various colors were chosen, which are resistant to combustion and have an electrical strength of at least 5 kV/mm, as well as flexibility and strength, allowing them to be placed on uneven surfaces of complex geometry. The adhesive layer of the selected films provides an average adhesion value (FINAT TM 1, after 24 hours, stainless steel) of 10N/25 mm at 20 °C. Acrylic adhesive was used for the examples.

A pattern containing the threshold operation temperature value in degrees Celsius was applied to the base with an adhesive layer using solvent dyes. The thermal composition was applied using the silk-screening technique in 5-7 layers. Between applications, the composition was dried in a vacuum chamber at 100 mm Hg and 20 °C for at least one hour, or in a thermostat at a temperature no higher than the operation temperature of the composition for at least three hours, or for 24 hours at room temperature. In its original state, the heat-sensitive material is white. The device was covered with a transparent adhesive elastic protective film.

### Example 2

Tetracosane with a phase transition temperature of 50 °C was used as an organic substance for preparing the heat-sensitive material according to example 1, polycaprolactone was used as a binder, and methanol was used as a solvent. The suspension was applied by silk-screening technique to a black Oramask 831 PVC film with an adhesive layer, having a thickness without an adhesive layer of 0.15 mm, according to the method described in Example 1, and the numerical threshold temperature value was applied in the zone free of the heat-sensitive material. The number of layers of heat-sensitive material was 7, and the composition was dried in a vacuum chamber at 100 mm Hg and 20 °C for one hour between applications. The thickness of the heat-sensitive material layer was 0.6 mm, and its area was 30% of the area of the front surface of the label. The device was covered with a transparent protective film made of PVC, 0.05 mm thick.

The device was glued at room temperature to a wavy surface with a radius of curvature of an individual bending element R=2 mm (FIG. 13a), which was then heated in a controlled manner at a speed of 1 °C/sec to a temperature of 50 °C with a given accuracy, and the fact of operation of the device was registered by visually recording an increase in the transparency of the heat-sensitive material with the development of the base color. The time during which the phase transition occurred and the transparency of the heat-sensitive material changed was 2 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 3

Ytterbium caprylate with a phase transition temperature of 60 °C was used as an organic substance for preparing the heat-sensitive material according to example 1, polyvinyl butyral was used as a binder, and a mixture of methanol with ethylene glycol methyl ether (50/50 vol. %) was used as a solvent. The suspension was applied by silk-screening technique to a red M-40 fluoroplastic film with an adhesive layer, having a thickness without an adhesive layer of 0.7 mm, according to the method described in Example 1, wherein the numerical threshold temperature value was applied in the zone of the heat-sensitive material before its application, and in the zone free from the heat-sensitive material, information about the service life was applied. The number of layers of heat-sensitive material was 7, and the composition was dried in a thermostat at 40 °C for three hours between applications. The thickness of the heat-sensitive material layer was 0.8 mm, and its area was 97% of the area of the front surface of the label. The device was covered with a transparent protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 60 °C with a given accuracy, and the fact of operation of the device was registered by visually recording an increase in the transparency of the heat-sensitive material with the development of the base color. The time during which the phase transition occurred and the transparency of the heat-sensitive material changed was 4 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 4

Eicosanoic acid with a phase transition temperature of 70 °C was used as an organic substance for preparing the heat-sensitive material according to example 1, melamine-formaldehyde resin was used as a binder, and a mixture of methanol and isobutanol (90/10 vol. %) was used as a solvent. The suspension was applied by silk-screening technique to a red vinyl-chloride vinyl-acetate copolymer film with an adhesive layer, having a thickness without an adhesive layer of 0.2 mm, according to the method described in Example 1, and the numerical threshold temperature value, as well as black paint, were applied in the zone of the heat-sensitive material before its application. The number of layers of heat-sensitive material was 5, and the composition was dried for 24 hours at room temperature between applications. The thickness of the heat-sensitive material layer was 0.2 mm, and its area was 70% of the area of the front surface of the label. The device was covered with a transparent protective film made of polyurethane modified with 15% trichloroisopropyl phosphate, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 70 °C with a given accuracy, and the fact of operation of the device was registered by visually recording an increase in the transparency of the heat-sensitive material with the development of the base color. The time during which the phase transition occurred and the transparency of the heat-sensitive material changed was 1 second. After cooling the device to room temperature, the preservation of the transparency of the heat-sensitive material was visually recorded. During heating and after cooling, it was found that the device remained tightly fixed to the wavy surface of the heating element and did not adhere off.

### Example 5

Dioctylphosphinic acid with a phase transition temperature of 80 °C was used as an organic substance for preparing the heat-sensitive material according to example 1, polyvinyl butyral was used as a binder, and ethanol was used as a solvent. The suspension was applied by silk-screening technique to a film made of a copolymer of vinyl chloride and vinylidene chloride, green in colour with reflective properties and an adhesive layer, having a thickness without an adhesive layer of 0.35 mm, according to the method described in Example 1, and the numerical threshold temperature value, as well as black paint, were applied in the zone of the heat-sensitive material before its application. The number of layers of heat-sensitive material was 5, and the composition was dried in a vacuum chamber at 100 mm Hg and 20 °C for one hour between applications. The thickness of the heat-sensitive material layer was 0.4 mm, and its area was 3% of the area of the front surface of the label. The device was covered with a transparent protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 80 °C with a given accuracy, and the fact of operation of the device was registered by visually recording an increase in the transparency of the heat-sensitive material with the development of the base color. The time during which the phase transition occurred and the transparency of the heat-sensitive material changed was 2 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 6

Yttrium behenate with a phase transition temperature of 90 °C was used as an organic substance for preparing the heat-sensitive material according to example 1, polybutyl methacrylate was used as a binder, and ethanol was used as a solvent. The suspension was applied by silk-screening technique to a polyvinylidene fluoride film, painted with orange with luminescent properties, and an adhesive layer, having a thickness without an adhesive layer of 0.15 mm, according to the method described in Example 1, and the numerical threshold temperature value, as well as black paint, were applied in the zone of the heat-sensitive material before its application. The number of layers of heat-sensitive material was 5, and the composition was dried in a thermostat at 70 °C for three hours between applications. The thickness of the heat-sensitive material layer was 0.2 mm, and its area was 30% of the area of the front surface of the label. The device was covered with a transparent protective film made of PVC, 0.05 mm thick.

The device was glued at room temperature to a wavy surface with a radius of curvature of an individual bending element R=2 mm (FIG. 13a), which was then heated in a controlled manner at a speed of 1 °C/sec to a temperature of 90 °C with a given accuracy, and the fact of operation of the device was registered by visually recording an increase in the transparency of the heat-sensitive material with the development of the base color. The time during which the phase transition occurred and the transparency of the heat-sensitive material changed was 4 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 7

Lanthanum palmitate with a phase transition temperature of 100 °C was used as an organic substance for preparing the heat-sensitive material according to example 1, gelatin was used as a binder, and isopropanol was used as a solvent. The suspension was applied by silk-screening technique to a polyester film modified with 6.5% hexabromocyclododecane, yellow in colour with an adhesive layer, having a thickness without an adhesive layer of 0.3 mm, according to the method described in Example 1, and the numerical threshold temperature value, as well as black paint, were applied in the zone of the heat-sensitive material before its application. The number of layers of heat-sensitive material was 6, and the composition was dried for 24 hours at room temperature between applications. The thickness of the heat-sensitive material layer was 0.5 mm, and its area was 30% of the area of the front surface of the label. The device was covered with a transparent protective film made of PVC, 0.05 mm thick.

The device was glued at room temperature to a wavy surface with a radius of curvature of an individual bending element R=2 mm (FIG. 13a), which was then heated in a controlled manner at a speed of 1 °C/sec to a temperature of 100 °C with a given accuracy, and the fact of operation of the device was registered by visually recording an increase in the transparency of the heat-sensitive material with the development of the base color. The time during which the phase transition occurred and the transparency of the heat-sensitive material changed was 2 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 8

Lanthanum nonadecinate with a phase transition temperature of 110 °C was used as an organic substance for preparing the heat-sensitive material according to example 1, phenoxy resin was used as a binder, and ethylene glycol was used as a solvent. The suspension was applied by silk-screening technique to a black Oramask 831 PVC film with an adhesive layer, having a thickness without an adhesive layer of 0.5 mm, according to the method described in Example 1, and the numerical threshold temperature value was applied in the zone free of the heat-sensitive material. The number of layers of heat-sensitive material was 6, and the composition was dried in a vacuum chamber at 100 mm Hg and 20 °C for one hour between applications. The thickness of the heat-sensitive material layer was 0.5 mm, and its area was 70% of the area of the front surface of the label. The device was covered with a transparent protective film made of PVC, 0.1 mm thick.

The device was glued at room temperature to a wavy surface with a radius of curvature of an individual bending element R=2 mm (FIG. 13a), which was then heated in a controlled manner at a speed of 1 °C/sec to a temperature of 110 °C with a given accuracy, and the fact of operation of the device was registered by visually recording an increase in the transparency of the heat-sensitive material with the development of the base color. The time during which the phase transition occurred and the transparency of the heat-sensitive material changed was 2 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 9

Lanthanum capronate with a phase transition temperature of 120 °C was used as an organic substance for preparing the heat-sensitive material according to example 1, polyethylene was used as a binder, and ethanol was used as a solvent. The suspension was applied by silk-screening technique to a black Oramask 831 PVC film with an adhesive layer, having a thickness without an adhesive layer of 0.5 mm, according to the method described in Example 1, and the numerical threshold temperature value was applied in the zone free of the heat-sensitive material. The number of layers of heat-sensitive material was 5, and the composition was dried in a thermostat at 60 °C for three hours between applications. The thickness of the heat-sensitive material layer was 0.35 mm, and its area was 70% of the area of the front surface of the label. The device was covered with a transparent protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 120 °C with a given accuracy, and the fact of operation of the device was registered by visually recording an increase in the transparency of the heat-sensitive material with the development of the base color. The time during which the phase transition occurred and the transparency of the heat-sensitive material changed was 3 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 10

Zinc nonadecanoate with a phase transition temperature of 130 °C was used as an organic substance for preparing the heat-sensitive material according to example 1, polycarbonate was used as a binder, and ethanol was used as a solvent. The suspension was applied by silk-screening technique to a black Oramask 831 PVC film with an adhesive layer, having a thickness without an adhesive layer of 0.45 mm, according to the method described in Example 1, and the numerical threshold temperature value was applied in the zone free of the heat-sensitive material. The number of layers of heat-sensitive material was 5, and the composition was dried for 24 hours at room temperature between applications. The thickness of the heat-sensitive material layer was 0.4 mm, and its area was 70% of the area of the front surface of the label. The device was covered with a transparent protective film made of PVC, 0.02 mm thick.

The device was glued at room temperature to a wavy surface with a radius of curvature of an individual bending element R=2 mm (FIG. 13a), which was then heated in a controlled manner at a speed of 1 °C/sec to a temperature of 130 °C with a given accuracy, and the fact of operation of the device was registered by visually recording an increase in the transparency of the heat-sensitive material with the development of the base color. The time during which the phase transition occurred and the transparency of the heat-sensitive material changed was 2 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 11

Zinc palmitate with a phase transition temperature of 140 °C was used as an organic substance for preparing the heat-sensitive material according to example 1, nitrocellulose was used as a binder, and ethanol was used as a solvent. The suspension was applied by silk-screening technique to a black Oramask 831 PVC film with an adhesive layer, having a thickness without an adhesive layer of 0.4 mm, according to the method described in Example 1, and the numerical threshold temperature value was applied in the zone free of the heat-sensitive material. The number of layers of heat-sensitive material was 6, and the composition was dried in a vacuum chamber at 100 mm Hg and 20 °C for one hour between applications. The thickness of the heat-sensitive material layer was 0.45 mm, and its area was 70% of the area of the front surface of the label. The device was covered with a transparent protective film made of PVC, 0.03 mm thick.

The device was glued at room temperature to a wavy surface with a radius of curvature of an individual bending element R=2 mm (FIG. 13a), which was then heated in a controlled manner at a speed of 1 °C/sec to a temperature of 140 °C with a given accuracy, and the fact of operation of the device was registered by visually recording an increase in the transparency of the heat-sensitive material with the development of the base color. The time during which the phase transition occurred and the transparency of the heat-sensitive material changed was 1 second. After cooling the device to room temperature, the preservation of the transparency of the heat-sensitive material was visually recorded. During heating and after cooling, it was found that the device remained tightly fixed to the wavy surface of the heating element and did not adhere off.

### Example 12

Zinc caproate with a phase transition temperature of 150 °C was used as an organic substance for preparing the heat-sensitive material according to example 1, polyvinylidene fluoride was used as a binder, and ethanol was used as a solvent. The suspension was applied by silk-screening technique to a black Oramask 831 PVC film with an adhesive layer, having a thickness without an adhesive layer of 0.2 mm, according to the method described in Example 1, and the numerical threshold temperature value was applied in the zone free of the heat-sensitive material. The number of layers of heat-sensitive material was 5, and the composition was dried in a thermostat at 60 °C for three hours between applications. The thickness of the heat-sensitive material layer was 0.3 mm, and its area was 70% of the area of the front surface of the label. The device was covered with a transparent protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 150 °C with a given accuracy, and the fact of operation of the device was registered by visually recording an increase in the transparency of the heat-sensitive material with the development of the base color. The time during which the phase transition occurred and the transparency of the heat-sensitive material changed was 1 second. After cooling the device to room temperature, the preservation of the transparency of the heat-sensitive material was visually recorded. During heating and after cooling, it was found that the device remained tightly fixed to the wavy surface of the heating element and did not adhere off.

### Example 13

Lithium stearate with a phase transition temperature of 210 °C was used as an organic substance for preparing the heat-sensitive material according to example 1, polybutyl acrylate was used as a binder, and ethanol was used as a solvent. The suspension was applied by silk-screening technique to a black Oramask 831 PVC film with an adhesive layer, having a thickness without an adhesive layer of 0.15 mm, according to the method described in Example 1, and the numerical threshold temperature value was applied in the zone free of the heat-sensitive material. The number of layers of heat-sensitive material was 5, and the composition was dried for 24 hours at room temperature between applications. The thickness of the heat-sensitive material layer was 0.4 mm, and its area was 70% of the area of the front surface of the label. The device was covered with a transparent protective film made of PVC, 0.1 mm thick.

The device was glued at room temperature to a wavy surface with a radius of curvature of an individual bending element R=2 mm (FIG. 13a), which was then heated in a controlled manner at a speed of 1 °C/sec to a temperature of 210 °C with a given accuracy, and the fact of operation of the device was registered by visually recording an increase in the transparency of the heat-sensitive material with the development of the base color. The time during which the phase transition occurred and the transparency of the heat-sensitive material changed was 1 second. After cooling the device to room temperature, the preservation of the transparency of the heat-sensitive material was visually recorded. During heating and after cooling, it was found that the device remained tightly fixed to the wavy surface of the heating element and did not adhere off.

### Example 14

Yttrium caproate with a phase transition temperature of 55 °C was used as an organic substance for preparing the heat-sensitive material according to example 1, polyethersulfone was used as a binder, and ethanol was used as a solvent. The suspension was applied by silk-screening technique to a black Oramask 831 PVC film with an adhesive layer, having a thickness without an adhesive layer of 0.25 mm, according to the method described in Example 1, and the numerical threshold temperature value was applied in the zone free of the heat-sensitive material. The number of layers of heat-sensitive material was 5, and the composition was dried in a vacuum chamber at 100 mm Hg and 20 °C for one hour between applications. The thickness of the heat-sensitive material layer was 0.25 mm, and its area was 70% of the area of the front surface of the label. The device was covered with a transparent protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 55 °C with a given accuracy, and the fact of operation of the device was registered by visually recording an increase in the transparency of the heat-sensitive material with the development of the base color. The time during which the phase transition occurred and the transparency of the heat-sensitive material changed was 3 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 15

N-hexadecyl-n-pentylhydrogenphosphate with a phase transition temperature of 40 °C was used as an organic substance for preparing the heat-sensitive material according to example 1, ethylcellulose was used as a binder, and ethanol was used as a solvent. The suspension was applied by silk-screening technique to a black Oramask 831 PVC film with an adhesive layer, having a thickness without an adhesive layer of 0.15 mm, according to the method described in Example 1, and the numerical threshold temperature value was applied in the zone free of the heat-sensitive material. The number of layers of heat-sensitive material was 5, and the composition was dried in a vacuum chamber at 100 mm Hg and 20 °C for one hour between applications. The thickness of the heat-sensitive material layer was 0.3 mm, and its area was 70% of the area of the front surface of the label. The device was covered with a transparent protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 40 °C with a given accuracy, and the fact of operation of the device was registered by visually recording an increase in the transparency of the heat-sensitive material with the development of the base color. The time during which the phase transition occurred and the transparency of the heat-sensitive material changed was less than 1 second. After cooling the device to room temperature, the preservation of the transparency of the heat-sensitive material was visually recorded. During heating and after cooling, it was found that the device remained tightly fixed to the wavy surface of the heating element and did not adhere off.

### Example 16

Palmitic acid anhydride with a phase transition temperature of 60 °C was used as an organic substance for preparing the heat-sensitive material according to example 1, polymethacrylate was used as a binder, and ethanol was used as a solvent. The suspension was applied by silk-screening technique to a black Oramask 831 PVC film with an adhesive layer, having a thickness without an adhesive layer of 0.35 mm, according to the method described in Example 1, and the numerical threshold temperature value was applied in the zone free of the heat-sensitive material. The number of layers of heat-sensitive material was 6, and the composition was dried in a thermostat at 40 °C for three hours between applications. The thickness of the heat-sensitive material layer was 0.55 mm, and its area was 70% of the area of the front surface of the label. The device was covered with a transparent protective film made of PVC, 0.02 mm thick.

The device was glued at room temperature to a wavy surface with a radius of curvature of an individual bending element R=2 mm (FIG. 13a), which was then heated in a controlled manner at a speed of 1 °C/sec to a temperature of 60 °C with a given accuracy, and the fact of operation of the device was registered by visually recording an increase in the transparency of the heat-sensitive material with the development of the base color. The time during which the phase transition occurred and the transparency of the heat-sensitive material changed was 2 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 17

Erucamide with a phase transition temperature of 80 °C was used as an organic substance for preparing the heat-sensitive material according to example 1, polycarbonate was used as a binder, and ethanol was used as a solvent. The suspension was applied by silk-screening technique to a black Oramask 831 PVC film with an adhesive layer, having a thickness without an adhesive layer of 0.65 mm, according to the method described in Example 1, and the numerical threshold temperature value was applied in the zone free of the heat-sensitive material. The number of layers of heat-sensitive material was 7, and the composition was dried for 24 hours at room temperature between applications. The thickness of the heat-sensitive material layer was 0.75 mm, and its area was 70% of the area of the front surface of the label. The device was covered with a transparent protective film made of PVC, 0.03 mm thick.

The device was glued at room temperature to a wavy surface with a radius of curvature of an individual bending element R=2 mm (FIG. 13a), which was then heated in a controlled manner at a speed of 1 °C/sec to a temperature of 80 °C with a given accuracy, and the fact of operation of the device was registered by visually recording an increase in the transparency of the heat-sensitive material with the development of the base color. The time during which the phase transition occurred and the transparency of the heat-sensitive material changed was 4 seconds. After cooling the device to room temperature, the preservation of the transparency of the heat-sensitive material was visually recorded. During heating and after cooling, it was found that the device remained tightly fixed to the wavy surface of the heating element and did not adhere off.

### Example 17

1-tetradecanol with a phase transition temperature of 40 °C was used as an organic substance for preparing the heat-sensitive material according to example 1, polybutyl acrylate was used as a binder, and ethanol was used as a solvent. The suspension was applied by silk-screening technique to a self-adhesive film made of chloroprene rubber on a black siliconized base with an adhesive layer of 0.1 mm, according to the method described in Example 1, and the numerical threshold temperature value was applied in the zone free of the heat-sensitive material. The number of layers of heat-sensitive material was 5, and the composition was dried in a vacuum chamber at 100 mm Hg and 20 °C for one hour between applications. The thickness of the heat-sensitive material layer was 0.15 mm, and its area was 70% of the area of the front surface of the label. The device was covered with a transparent protective film made of PVC, 0.05 mm thick.

The device was glued at room temperature to a wavy surface with a radius of curvature of an individual bending element R=2 mm (FIG. 13a), which was then heated in a controlled manner at a speed of 1 °C/sec to a temperature of 40 °C with a given accuracy, and the fact of operation of the device was registered by visually recording an increase in the transparency of the heat-sensitive material with the development of the base color. The time during which the phase transition occurred and the transparency of the heat-sensitive material changed was less than 1 second. After cooling the device to room temperature, the preservation of the transparency of the heat-sensitive material was visually recorded. During heating and after cooling, it was found that the device remained tightly fixed to the wavy surface of the heating element and did not adhere off.

### Example 18

Docosanitrile with a phase transition temperature of 55 °C was used as an organic substance for preparing the heat-sensitive material according to example 1, polybutyl methacrylate was used as a binder, and ethanol was used as a solvent. The suspension was applied by silk-screening technique to a black Oramask 831 PVC film with an adhesive layer, having a thickness without an adhesive layer of 0.15 mm, according to the method described in Example 1, and the numerical threshold temperature value was applied in the zone free of the heat-sensitive material. The number of layers of heat-sensitive material was 5, and the composition was dried for 24 hours at room temperature between applications. The thickness of the heat-sensitive material layer was 0.25 mm, and its area was 70% of the area of the front surface of the label. The device was covered with a transparent protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 55 °C with a given accuracy, and the fact of operation of the device was registered by visually recording an increase in the transparency of the heat-sensitive material with the development of the base color. The time during which the phase transition occurred and the transparency of the heat-sensitive material changed was 1 second. After cooling the device to room temperature, the preservation of the transparency of the heat-sensitive material was visually recorded. During heating and after cooling, it was found that the device remained tightly fixed to the wavy surface of the heating element and did not adhere off.

### Example 19

N-docosylamine with a phase transition temperature of 65 °C was used as an organic substance for preparing the heat-sensitive material according to example 1, polyvinyl butyral was used as a binder, and ethanol was used as a solvent. The suspension was applied by silk-screening technique to a black OraJet 3106SG PVC film with an adhesive layer, having a thickness without an adhesive layer of 0.55 mm, according to the method described in Example 1, and the numerical threshold temperature value was applied in the zone free of the heat-sensitive material. The number of layers of heat-sensitive material was 7, and the composition was dried in a vacuum chamber at 100 mm Hg and 20 °C for one hour between applications. The thickness of the heat-sensitive material layer was 0.75 mm. The size of the front surface of the label is 12*12 mm (area—144 mm²), the size of the layer of heat-sensitive material is 10*10 mm (area—100 mm²). The device was covered with a transparent protective film made of PVC, 0.05 mm thick.

The device was installed at room temperature on a flat surface of a heating element. Part of the heating element was heated in a controlled manner at a speed of 1 °C/sec to a temperature of 65 °C with a given accuracy, while the remaining part of the heating element was not heated. The fact of operation of the part of the device that was subjected to heating was registered by visually recording an increase in the transparency of the corresponding section of the heat-sensitive material with the development of the base color. After cooling the device to room temperature, the transparency of the corresponding area of the heat-sensitive material was visually recorded. Then the heating element was completely heated at a speed of 1 °C/sec to a temperature of 65 °C with a given accuracy. The fact of the complete operation of the device was registered by visually recording an increase in the transparency of the entire layer of heat-sensitive material with the development of the base color. The time during which the phase transition occurred and the transparency of the heat-sensitive material changed was 2 seconds. During heating and cooling cycles, it was found that the device remained tightly fixed to the wavy surface of the heating element and did not adhere off.

### Example 20

The area of the black OraJet 3951 PVC film with an adhesive layer, onto which the heat-sensitive material will be applied, was sealed with a protective polyethylene film, and the free area was covered with pigmented yellow Tempilaq thermal paint with a reversible color change temperature of 113 °C. After the paint had dried, the protective polyethylene film was removed and, using solvent dyes, the numerical threshold temperature value was applied to the surface of the base containing the thermal paint. The thickness of the base containing thermal paint was 0.45 mm. Then a protective polyethylene film was glued to the area where the heat-sensitive material should not come into contact, and the thermal compound was applied by silk-screening technique in 7 layers. After the layer had completely dried, the protective film was removed. Lanthanum nonadecinate with a phase transition temperature of 110 °C was used as an organic substance for preparing the heat-sensitive material according to example 1, butyl methacrylic resin was used as a binder, and ethanol was used as a solvent. The number of layers of heat-sensitive material was 6, and the composition was dried in a thermostat at 60 °C for three hours between applications. The thickness of the heat-sensitive material layer was 0.6 mm, and its area was 70% of the area of the front surface of the label. The device was covered with a transparent elastic protective film made of PVC, 0.05 mm thick.

The device was glued at room temperature to a wavy surface with a radius of curvature of an individual bending element R=2 mm (FIG. 13a), which was then heated in a controlled manner at a speed of 1 °C/sec to a temperature of 115 °C with a given accuracy, and the fact of operation of the zone of the heat-sensitive material of the device with the development of the base color, as well as the fact of operation of the thermal paint with a change in color were recorded. The time during which the phase transition occurred and the transparency of the heat-sensitive material changed was 1 second. After cooling the device to room temperature, the preservation of the transparency of the heat-sensitive material zone and the return of the color of the thermal paint to its original color were visually recorded. During heating and after cooling, it was found that the device remained tightly fixed to the wavy surface of the heating element and did not adhere off.

### Example 21

The area of the red Oramask 831 PVC film with an adhesive layer, onto which the heat-sensitive material will be applied, was sealed with a protective polyethylene film, the free area was covered with pigmented yellow Hallcrest SC thermal paint with an irreversible color change temperature of 80 °C. After the paint had dried, the protective polyethylene film was removed and, using solvent dyes, the numerical threshold temperature value was applied to the surface of the base containing the thermal paint. The thickness of the base containing thermal paint was 0.55 mm. Then a protective polyethylene film was glued to the area where the heat-sensitive material should not come into contact, this area was covered with solvent black dye and the thermal composition was applied by silk-screening technique in 6 layers. After the layer had completely dried, the protective film was removed. Zinc caproate with a phase transition temperature of 150 °C was used as an organic substance for preparing the heat-sensitive material according to example 1, phenol-formaldehyde resin was used as a binder, and ethanol was used as a solvent. The number of layers of heat-sensitive material was 6, and the composition was dried in a vacuum chamber at 100 mm Hg and 20 °C for one hour between applications. The thickness of the heat-sensitive material layer was 0.45 mm, and its area was 30% of the area of the front surface of the label. The device was covered with a transparent elastic protective film made of PVC, 0.15 mm thick.

The device was glued at room temperature to a wavy surface with a radius of curvature of an individual bending element R=2 mm (FIG. 13a), which was then heated in a controlled manner at a speed of 1 °C/sec to a temperature of 80 °C with a given accuracy, and the fact of operation of the thermal paint with a change in color was recorded. Then heating was continued to a temperature of 150 °C and the fact of operation of the zone of the heat-sensitive material of the device with the development of the base color was recorded. The time during which the phase transition occurred and the transparency of the heat-sensitive material changed was 2 seconds. After cooling the device to room temperature, the preservation of the transparency of the heat-sensitive material zone and the preservation of the changed color of the thermal paint were visually recorded. During heating and after cooling, it was found that the device remained tightly fixed to the wavy surface of the heating element and did not adhere off.

### Example 22

To determine the elongation at break, the devices manufactured according to examples 2-21 were glued to rubber plates 1 cm thick, the linear dimensions of which were 1-3 cm larger than the linear dimensions of the corresponding devices on each side. Each sample was subjected to the following tests. One end of the rubber plate was tightly secured together with the device glued to it, and force was applied to the opposite ends of the plate and the device, the plate with the device was stretched by 10% of the corresponding original size and secured in this position. In a similar manner, one of the remaining free ends of the plate and the device glued to it was tightly secured, the plate with the device was stretched by the opposite ends in a direction perpendicular to the initial stretching, and secured in this position. In this case, the preservation of tight adhesion of each device manufactured according to examples 2-21 to the surface of the corresponding plate was established.

The stretched plate with the device was placed in a thermostat and heated in a controlled manner to the corresponding threshold temperature at a speed of 0.1 °C/sec. The complete operation of each tested device was recorded upon reaching the threshold temperature with a specified accuracy. After cooling to room temperature, the transparency of the temperature-sensitive material was detected on each test device. After the stretching was removed, the transparency of the heat-sensitive material of each test device, as well as the integrity of the device itself and the heat-sensitive material layer, were preserved.

The results of the tests conducted prove the achievement of a technical result, namely, an increase in the safe operation of various equipment, including electrical equipment, due to the possibility of tightly fitting the device to surfaces of complex geometry, as well as to surfaces whose linear dimensions can increase within 10%, while maintaining the ability to accurately record the excess of threshold temperatures.

The patent was disclosed above with reference to a specific variant. Other variants of the patent that do not change its essence as disclosed in this description may be obvious to specialists. Accordingly, the patent should be considered not limited in scope by the description and examples provided.

1. The device for recording the excess of threshold temperature, which is an elastic label having a layered structure, including:
an adhesive layer;
a colored elastic base containing at least 5 mass % of halogen atoms, onto which information is applied, including the numerical value of the recorded threshold temperature;
a heat-sensitive material applied to a section of the front surface of the base, made with the ability of visually recording overheating due to an irreversible change in transparency relative to the original state when heated in the range of ±5 °C from the threshold temperature indicated on the label, and including a solid organic substance with a structural fragment of ₙH₍₂ₙ₊₁₎, where n≥5;
an elastic protective film, transparent to at least part of visible light, covering the front surface of the base and the heat-sensitive material,
wherein the device is designed with the ability to maintain the function of visually recording overheating in the range of ±5 °C from the threshold temperature indicated on the label after its mounting on a cylindrical surface, the minimum radius of curvature of which is 2 mm, as well as after longitudinal and transverse stretching by 10% relative to the original size.

2. The device according to claim 1, wherein it has dielectric properties, preferably has an electrical strength of at least 5 kV/mm.

3. The device according to claim 1, wherein the elastic base includes polymers containing the structural unit —CH₂CHCl—, predominantly polyvinyl chloride, predominantly cast polyvinyl chloride.

4. The device according to claim 1, wherein the thickness of the elastic base is preferably no more than 0.7 mm, the thickness of the heat-sensitive material is preferably 0.8 mm, and the thickness of the transparent elastic film is preferably 0.15 mm.

5. The device according to claim 1, wherein the adhesion of the label to stainless steel, measured using the FINAT TM1 method, at 20 °C is at least 10N/25 mm.

6. The device according to claim 1, wherein the transparent elastic protective film is made of polyvinyl chloride, preferably cast polyvinyl chloride.

7. The device according to claim 1, wherein the elongation before break of the elastic base is at least 10%, and the elongation before break of the elastic protective film is at least 33%.

8. The device according to claim 1, wherein the heat-sensitive material in its original state has a microstructure that includes a continuous solid phase and voids filled with the gas phase, and is designed with the ability to irreversibly change its appearance upon reaching the specified threshold temperature due to the destruction of the microstructure of the heat-sensitive material, accompanied by the fusion of particles of solid organic substance, a decrease in the fraction of voids and an increase in its transparency with the development of the base color.

9. The device according to claim 1, wherein the organic substance of the solid phase of the heat-sensitive material can be selected from the group: fatty aliphatic acids containing structural fragments CₙH₍₂ₙ₊₁₎ with n≥12; salts of fatty aliphatic acids containing structural fragments CₙH₍₂ₙ₊₁₎ with n≥5; alkanes containing at least 20 carbon atoms; dialkylphosphinic acids containing structural fragments CₙH₍₂ₙ₊₁₎ with n≥5; amides of fatty aliphatic acids containing structural fragments CₙH₍₂ₙ₊₁₎ with n≥5; anhydrides of fatty aliphatic acids containing structural fragments CₙH₍₂ₙ₊₁₎ with n≥10; fatty aliphatic alcohols containing structural fragments CₙH₍₂ₙ₊₁₎ with n≥14; fatty aliphatic amines containing structural fragments CₙH₍₂ₙ₊₁₎ with n≥17; nitriles of fatty aliphatic acids containing structural fragments CₙH₍₂ₙ₊₁₎ with n≥19.

10. The device according to claim 1, wherein the organic substance of the solid phase substance of the heat-sensitive material is selected from the group: palmitic acid, stearic acid, behenic acid, tetracosane, erucamide, stearyl alcohol, cetyl alcohol, polyethylene, wax, paraffin, salts of saturated fatty carboxylic acids of rare earth metals, in particular lanthanum, yttrium, ytterbium, scandium.

11. The device according to claim 1, wherein the mass content of the solid organic substance containing the structural fragment CₙH₍₂ₙ₊₁₎), where n≥5, or a group of substances, each of which contains the structural fragment CₙH₍₂ₙ₊₁₎, where n≥5, is at least 50 mass % in the heat-sensitive material.

12. The device according to claim 1, wherein the heat-sensitive material additionally contains a polymer binder that is transparent to at least part of visible light in an amount of 1-30 mass %.

13. The device according to claim 1, wherein the heat-sensitive material is designed with the ability to change transparency when heated to a temperature exceeding the threshold, within no more than 5 seconds.

14. The device according to claim 1, wherein the threshold temperature is selected from the range of 50-210 °C, preferably 50 °C, 55 °C, 60 °C, 70 °C, 80 °C, 90 °C, 100 °C, 110 °C, 120 °C, 130 °C, 140 °C, 150 °C.

15. The device according to claim 1, wherein the coloring of the elastic base or the inscription is designed to enable marking of electrical equipment elements or color marking of phases.

16. The device according to claim 1, wherein the surface area of the base covered with the heat-sensitive material is at least 100 mm².

17. The device according to claim 1, designed with the ability of recording overheating of individual sections of the surface by changing the color of only that part of the heat-sensitive material that was heated above the threshold temperature and maintaining the original color of the heat-sensitive material that was not heated above the threshold temperature.

18. The device according to claim 1, wherein the heat-sensitive material in the original state is colored white, and when the transparency of the heat-sensitive material changes, a visual color transition of the corresponding part of the surface of the device from white to black occurs.

19. The device according to claim 1, wherein the elastic base has reflective properties.

20. The device according to claim 1, wherein the base is colored using a substance having luminescent properties.

21. The device according to claim 1, wherein the base is colored using a substance made with the ability to reversibly change color upon heating.

22. The device according to claim 1, wherein the base is colored using a substance made with the ability to irreversibly change color when heated.
